(19) United States
(12) Patent Application Publication
(10) Pub. No.: US 2020/0361602 A1
(43) Pub. Date: Nov. 19, 2020

(54) Reciprocating Lift and Thrust Systems

(71) Applicant: Yiding Cao, Miami, FL (US)

(72) Inventor: Yiding Cao, Miami, FL (US)

(21) Appl. No.: 16/967,200

(22) PCT Filed: Mar. 11, 2019
(86) PCT No.: PCT/US2019/021636

§ 371 Date: Aug. 4, 2020

Related U.S. Application Data
(60) Provisional application No. 62/761,109, filed on Mar. 12, 2018.
(60) Provisional application No. 62/739,317, filed on Sep. 30, 2018.

(51) Int. Cl. B64C 33/02; B64C 29/00

(52) U.S. Cl. CPC B64C 33/02; B64C 29/0008

(57) ABSTRACT

A reciprocating lift and thrust system include at least an airfoil and a reciprocating driver configured to produce a reciprocating motion of the airfoil. The system may further include a control unit to change or maintain a suitable angle of attack of the airfoil for lift or thrust as well as to facilitate the cyclic control of the flying vehicle driven by the reciprocating system. The lift and thrust system may be deployed in a module that includes at least two reciprocating airfoils (RAs) and is configured to substantially cancel out the inertia forces and moments associated with the individual airfoils. The reciprocating driver maybe, but not limited to, a mechanical, electromagnetic, electrical, or hydraulic driver. The embodiments of the subject invention provide novel and advantageous RA-driven aircraft, RA-driven flying motor vehicles, and RA-driven watercraft.

This application is a national stage application of the International Patent Application: Reciprocating Lift and Thrust Systems (PCT/US2019/021636).

### BACKGROUND OF THE INVENTION

The use of airfoils by fixed-wing aircraft has the benefit of attaining an increased lift as compared to the thrust needed to overcome the aerodynamic resistance and sustain the flight of the aircraft. In general, a fixed-wing aircraft with finite-span airfoils may have a lift ten times greater than the needed thrust that may be provided by a jet engine or propeller, resulting in a great leverage ratio by using fixed wings. In conjunction with other advantages, the fixed-wing aircraft have become a mass-transportation means in most countries. However, the generation of a sufficiently high lift requires a substantially high aircraft speed, and subsequently, a runway for aircraft takeoff or landing is needed.

Helicopters or rotorcraft have been developed for vertical takeoff and landing as well as easier maneuvering in the air at a low speed. But the use of the helicopter so far is rather limited, far from being a mass transportation means, which may represent a grand challenge. Since the vertical takeoff and landing (VTOL) aircraft may be a potentially more efficient and convenient means of transportation for passengers and goods as compared to fixed-wing aircraft, overcoming this grand challenge may have the potential to revolutionize passenger transportation, improve the quality of people's lifestyle, and better utilize the territory of many countries.

The challenges that hold back the use of helicopters may include, but not limited to, the following: (1) Significant vibratory loads in forward flight, very complex aerodynamic environments involving the wide and intense vorticity field released by the main rotor, and blade-vortex interactions, which may cause adverse operational conditions for helicopters including tiltrotor helicopters, such as the vortex ring state; (2) Poor safety track record based on their fatal accident rates in comparison with fixed-wing airplanes and difficult to operate by non-professional pilots; (3) Much lower global lift-to-drag ratio of the main rotor during takeoff and landing as well as cruise than that of fixed-wing aircraft, resulting in substantially increased power consumption and reduced flight range; (4) Generation of very strong wind and loud noise during takeoff or landing, both of which are negative factors that may hinder mass adoption of the helicopter; and (5) System complexity, anti-torque mechanisms, high costs, and large footprint. It is understood that in the past, many technological advancements or innovations have been made to improve the performance and safety of the helicopter. However, they may also add additional complexity and costs, which may further hinder the mass adoption of the helicopter.

### SUMMARY OF THE INVENTION

Embodiments of the subject invention provide novel and advantageous reciprocating lift or thrust systems for vehicles that leverage the high lift-to-drag ratio of airfoils without requiring a runway. In particular, the invention produces reciprocating airfoil systems that enable aircraft takeoff, landing, hovering, or easier maneuvering in the air without relying on a complex rotary-wing system associated with rotorcraft. The invented reciprocating-airfoil system may match or exceed the performance of a fixed wing, but without incurring many technical difficulties and high costs of a rotorcraft. The invention also creates reciprocating thrust systems to provide thrust for the vehicle to fly. The lift or thrust system includes at least an airfoil and a reciprocating driver that engages said airfoil and generates a reciprocating motion of the airfoil. A control unit may be included to generate suitable airfoil's angles of attack in reciprocating cycles for needed lift or thrust. The lift or thrust system may be deployed in terms of a module that includes at least two airfoils configured to substantially cancel out the inertia forces and moments associated with the individual airfoils.

An application of this invention is to create aircraft within a broad category of vertical takeoff and landing (VTOL) vehicles. In addition to the aircraft for conventional transportation purposes, the reciprocating lift and thrust systems of this invention may be employed for military jets, unmanned aerial vehicles (UAV), personal vehicles, and recreational aircraft. The reciprocating thrust system of this invention may also work in place of the propeller or jet engine of fixed-wing aircraft using a runway for takeoff and landing.

Yet another application of the reciprocating lift and thrust systems of this invention is to create flying motor vehicles, such as but not limited to, flying cars, flying busses, flying trucks, flying motorcycles, and flying off-road vehicles, to enable vertical takeoff and landing as well as traveling either in the air or on the ground.

Yet another application of this invention is to provide thrust for ships, submarines, and boats. In addition to the applications mentioned herein, the disclosed reciprocating lift and thrust systems may find other industrial applications as well.

Compared to helicopters or rotorcraft, the reciprocating lift or thrust system according to this invention may have the following technological advantages: (1) Unlike the rotary motion of the main rotor in a rotorcraft, the motion of the airfoil of this invention is reciprocating and primarily linear during the operation, and the primary concern related to potential vibration is the balance of the inertia forces and moments due to the reciprocating motion. The system may be easily balanced by using more than one airfoil unit, similar to the use of multiple pistons and cylinders in a reciprocating compressor or engine. Many problems related to vibratory loads, wide and intense vorticity field, and blade-vortex interactions, as well as anti-torque mechanisms, are removed. Thus, an aircraft built upon the system of this invention may have significantly improved safety and reliability; (2) When a crankshaft mechanism is used for the reciprocating driver of this invention, the cost of the driver system may be potentially much lower than the cost of the main rotor of a helicopter because of the use of conventional mechanical components and fixed-wing airfoil structures. The lower costs of the aircraft of this invention may enable their penetration into mass markets; (3) The performance of a reciprocating airfoil may match or exceed the performance of a wing of similar size in a fixed-wing aircraft and can have a lift and lift-to-drag ratio much greater than those of a helicopter's main rotor. Consequently, an aircraft equipped with the present lift or thrust system could have a significantly improved flight range due to the greatly increased energy efficiency. The aircraft of this invention can also fly much faster than the helicopter because the reciprocating airfoils of this invention may be shaped like fixed wings and function as fixed wings during the cruise. The aircraft of this invention is thus a natural extension of fixed-wing aircraft with added reciprocating-motion functionality of the airfoils for vertical takeoff and landing; (4) Great modularity and controllability are other advantages of the system of this invention. In particular, multiple airfoil assemblies may be flexibly deployed at different locations of a vehicle for the benefits of the operation and balancing inertia forces and moments. For example, a plurality of airfoils may be arranged on the top or bottom surface of a vehicle, which may share the same reciprocating driver or be driven by separate drivers. Additionally, more than one airfoil assembly may be deployed in a vertical direction, which may share the same reciprocating driver. For rotorcraft, however, the deployment of multiple rotors is a challenging undertaking. For these reasons, an aircraft of this invention may be able to deploy much larger airfoil area per unit volume of the aircraft main body, resulting in a significantly reduced footprint as compared to a helicopter of similar loads; and (5) In a fixed-wing aircraft, the lift-to-drag ratio of a finite-span wing is significantly lower than that of a corresponding infinite-span airfoil due to the trailing-edge vortex that creates a downward velocity component, called downwash. Due to the reciprocating motion of the airfoil of this invention at a sufficiently high frequency, the trailing-edge vortex may be difficult to grow. Considering the motion of an airfoil with a finite span from the right end to the left end in a stroke, the trailing-edge vortex may attempt to develop near the trailing edge at the right end of the airfoil. However, before the trailing-edge vortex may have fully established, the airfoil may have reached the left dead end. The left leading edge becomes a trailing edge, and the right trailing edge becomes a leading-edge while the airfoil changes direction and moves from left to right. These combined actions may quickly destroy the trailing-edge vortex before it is fully established. Consequently, the lift-to-drag ratio of the airfoil of this invention with a finite span may potentially approach that of an airfoil with an infinite span.

### BRIEF DESCRIPTION OF THE DRAWINGS

FIG. 1 shows a schematic illustration of a sectional view of a reciprocating lift or thrust system according to an embodiment of the subject invention, showing an airfoil assembly being driven by a reciprocating driver and moving from the right to the left with a suitable angle of attack in a stroke,

FIG. 2 shows a schematic illustration of a sectional view of a reciprocating lift or thrust system according to an embodiment of the subject invention, showing the airfoil assembly moving from the left to the right with a suitable angle of attack in the following, reverse stroke,

FIG. 3 shows a schematic illustration of a sectional view of a reciprocating lift or thrust system according to an embodiment of the subject invention, showing an airfoil section on the right being deflected downward by a control mechanism while the airfoil assembly moving from the right to the left in a stroke,

FIG. 4 shows a schematic illustration of a sectional view of a reciprocating lift or thrust system according to an embodiment of the subject invention, showing an airfoil section on the left being deflected downward by a control mechanism while the airfoil assembly moving from the left to the right in the following stroke,

FIG. 4a shows a schematic illustration of a sectional view of a reciprocating lift or thrust system according to an embodiment of the subject invention, showing the implementation of an airfoil leading edge slat,

FIG. 5 shows a schematic illustration of a sectional view of a reciprocating lift or thrust system according to an embodiment of the subject invention, showing the center of rotation of an airfoil being disposed at a location away from the airfoil,

FIG. 5a shows a schematic illustration of a sectional view of a reciprocating lift or thrust system according to an embodiment of the subject invention, showing more than one airfoil being disposed in a substantially vertical direction and both airfoil assemblies sharing a reciprocating driver.

FIG. 6 shows a schematic, sectional view of an embodiment of a reciprocating driver employing a crankshaft mechanism as well as control mechanisms to tilt, raise, or lower the airfoil reciprocating plane,

FIG. 6a shows a schematic, sectional view of an embodiment of the reciprocating driver employing a crankshaft, with at least a spring coil or spring coil assembly being disposed to reduce inertia forces related stresses in reciprocating members,

FIG. 7 shows a schematic, sectional view of an embodiment of a reciprocating driver employing a crankshaft that generates a reciprocating motion of a beam structure on which an airfoil assembly being mounted, said airfoil assembly moving along with the beam,

FIG. 8 shows a schematic, sectional view of an embodiment of an electromagnetic reciprocating driver, employing a pair of electromagnets and a pair of permanent magnets to generate a reciprocating motion of an airfoil assembly,

FIG. 9a shows a schematic, sectional view of an embodiment of a hydraulic reciprocating driver, which employs a larger piston and a smaller piston in a liquid loop to attain an increased reciprocating stroke of an airfoil assembly,

FIG. 9b shows a schematic, sectional view of an embodiment of a hydraulic reciprocating driver, which couples the motion of the smaller piston with that of the airfoil assembly through magnetic forces,

FIG. 9c shows a schematic view of an embodiment of a hydraulic reciprocating driver, which uses the smaller-piston related loop section as the track of an airfoil assembly and couples the motion of the smaller piston with that of the airfoil assembly through a truss structure,

FIG. 9d shows a schematic view of an embodiment of a hydraulic reciprocating driver, which couples the motion of the smaller piston with that of the airfoil assembly without a bearing on the outer surface of the smaller-piston related loop section,

FIG. 10 shows a schematic, top view of the crankshaft and airfoil assemblies with an opposed arrangement for the cancellation of inertia forces and moments, with two airfoils generally reciprocating in a lateral direction of a vehicle,

FIG. 10a shows a schematic, top view of an arrangement of the crankshaft, airfoil assemblies, and fixed wings, with the crankshaft being deployed in a generally perpendicular direction to a vehicle's main body, and said airfoils reciprocating in a lateral direction of the vehicle and being supported by the fixed wings,

FIG. 11 shows a schematic, top view of an arrangement of crankshaft and airfoil assemblies for cancellation of inertia forces and moments, said airfoils being disposed in a longitudinal direction of a vehicle and reciprocating in a front-back direction of the vehicle,

FIG. 11a shows a schematic, top view of two airfoils in a RA module, which is disposed in a longitudinal direction of a vehicle and reciprocating in a front-back direction of the vehicle, with recesses to accommodate the rotation of the cranks for reduction of the distance between the vehicle main body (or fuselage) and the airfoils/reciprocating driver,

FIG. 11b shows a schematic, top view of two airfoils in an RA module, which is disposed in a longitudinal direction of a vehicle and reciprocating in a front-back direction of the vehicle, with the crankshaft being installed in a vertical position to reduce the distance between the vehicle main body and the airfoils,

FIG. 11c shows a schematic, top view of two airfoils in an RA module with the incorporation of a bar/slider mechanism to increase the reciprocating stroke of the airfoils for a given crank radius,

FIG. 11d shows a schematic, top view of two airfoils in an RA module with the incorporation of a bar/slider mechanism to increase the reciprocating stroke of the airfoils for a given crank radius in conjunction with fixed tracks,

FIG. 11e shows a schematic, top view of two RA modules that are deployed in a longitudinal direction of the vehicle while reciprocating in a forward-backward direction, driven by a crankshaft mechanism,

FIG. 12 shows a schematic view of an aircraft employing a reciprocating lift and thrust system of this invention, wherein said reciprocating system producing lift for vertical takeoff and landing, or hovering of the aircraft with the airfoils reciprocating in a longitudinal direction of the aircraft,

FIG. 13 shows a schematic view of an aircraft employing a reciprocating lift and thrust system of this invention during aircraft vertical takeoff and landing, or hovering, with the airfoils reciprocating in a lateral direction of the aircraft,

FIG. 14a shows a schematic view of an aircraft employing a reciprocating lift and thrust system of this invention during forward flight, with airfoils being tilted forwardly while reciprocating in a longitudinal direction of the aircraft,

FIG. 14b shows a schematic view of an aircraft employing a reciprocating lift and thrust system of this invention during forward flight, with airfoils being tilted forwardly while reciprocating in a lateral direction of the aircraft,

FIG. 15 shows a schematic view of an aircraft employing a reciprocating lift and thrust system of this invention, utilizing a reciprocating thrust system of this invention to provide thrust and another reciprocating lift and thrust system for lift,

FIG. 15a shows a schematic view of an aircraft employing a reciprocating lift and thrust system of this invention, utilizing a reciprocating thrust system of this invention for thrust, and two airfoils in another reciprocating lift and thrust system for the lift by forming combined, fixed wings during the cruise,

FIG. 16 shows a schematic, sectional view of a reciprocating thrust system according to this invention,

FIG. 17 shows a schematic view of an aircraft employing a reciprocating lift and thrust system of this invention for lift while utilizing a propeller for thrust,

FIG. 18 shows a schematic view of an aircraft employing a reciprocating lift and thrust system of this invention for lift while utilizing a jet engine for the thrust during cruise,

FIG. 19 shows a schematic view of an aircraft employing reciprocating lift and thrust systems of this invention for the lift in conjunction with fixed wings while employing a propeller for thrust,

FIG. 20 shows a schematic view of an aircraft employing a reciprocating thrust system of this invention for thrust while utilizing fixed wings for aircraft lift,

FIG. 21 shows a schematic view of a flying car employing reciprocating lift and thrust systems of this invention, utilizing a reciprocating thrust system of this invention to drive the car while traveling on the ground,

FIG. 22 shows a schematic view of a flying car employing a reciprocating lift and thrust system of this invention for both lift and thrust while the car is flying in the air,

FIG. 23 shows a schematic view of a submarine employing a reciprocating thrust system of this invention to provide thrust,

FIG. 24 shows a schematic, sectional view of an embodiment of a mechanical control unit, said unit being actuated near or at a dead-end of a stroke of an airfoil assembly,

FIG. 25 shows a schematic, enlarged partial view of the mechanical control unit in FIG. 24, including a stopper and a mechanical moving contact,

FIG. 26 shows a schematic illustration of an embodiment of the control system using a modified rack-pinion gear unit.

FIG. 27 shows a schematic view of an embodiment of a mechanical control unit, employing a Scott Russell linkage mechanism to rotate an airfoil around a rotating center near the leading edge,

FIG. 28 shows a schematic view of an embodiment of a mechanical control unit, utilizing the reciprocating swing motion of a connecting rod in conjunction with a gear system to actuate the change of the angle of attack of the airfoil,

FIG. 29 shows a schematic, sectional view of an embodiment of the electromagnetic or electrical control unit, said unit being actuated near or at a dead-end of a stroke of an airfoil assembly, and FIG. 30 shows a schematic, enlarged partial view of the electromagnetic or electrical control unit in FIG. 29, including a non-reciprocating electrical contact and a reciprocating electrical contact.

### DETAILED DESCRIPTION OF THE INVENTION

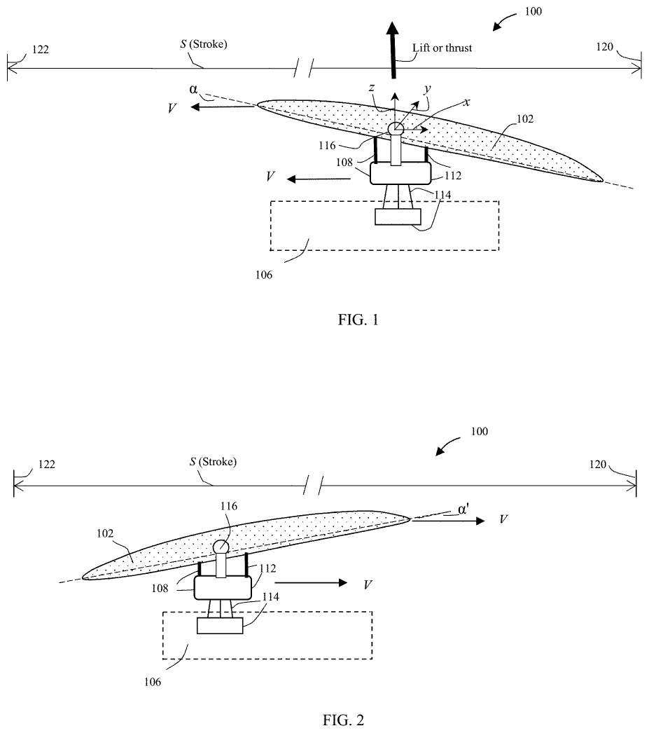

FIG. 1 shows a schematic illustration of a sectional view of a reciprocating lift or thrust system according to an embodiment of the subject invention. Referring to FIG. 1, the system 100 comprises an airfoil 102 and a reciprocating driver 106 that may produce a reciprocating motion of the airfoil 102 with a stroke S. Said stroke may be defined based on any section of the airfoil and it may be related to a reference section such as a midsection of the airfoil. In FIG. 1, said airfoil 102 travels toward the left dead-end 122 of the stroke with a positive angle of attack α, producing a lift or thrust. The system further comprises a control unit with an embodiment 108 or 112 shown in the figure. Near or at the left dead-end 122, the activation of the control unit 108 or 112 may generate a counter-clockwise rotation of the airfoil around a joint mechanism 116 by an angle as the airfoil changes direction and moves from the left end 122 toward the right end 120 with an angle of attack α′, as shown in FIG. 2. As the airfoil is near or at the right end 120 of the stroke, the action of the control mechanism may produce clockwise rotation of the airfoil by an angle as the airfoil changes direction and moves from the right end toward the left end, returning to the condition shown in FIG. 1 and completing a reciprocating cycle.

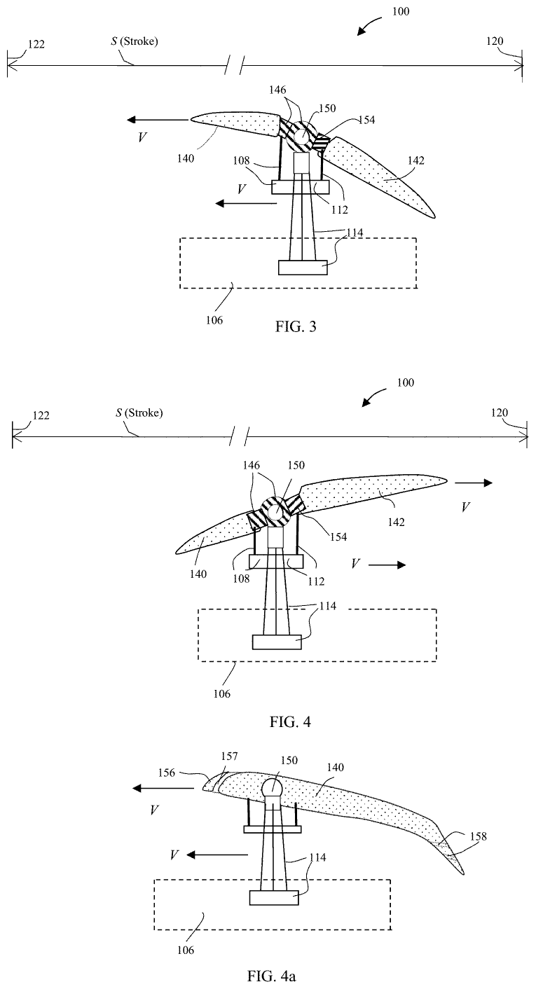

It is well known in the airfoil field that trailing-edge high-lift mechanisms comprising a trailing edge flap are commonly employed during the takeoff and landing of fixed-wing aircraft. Similar principles may be adapted for the present reciprocating lift or thrust system. FIG. 3 shows a schematic, sectional view of an embodiment with two airfoil sections, 140 and 142. Referring to FIG. 3, the airfoil section 140 moves to the left dead-end 122 with a positive angle of attack. The airfoil section 142 is deflected downward by the control mechanism 112 while moving along from the right end to the left end. Similar to the trailing edge flap mechanism of a fixed-wing aircraft, this downward defection of the airfoil section 142 may significantly increase the lift or thrust of the system. When the airfoil assembly is near or at the left dead-end 122 of the stroke, the control mechanisms 112 is activated to push the airfoil section 142 upward, while the airfoil section 140 is deflected downward by the control mechanism 108, as the airfoil assembly travels from the left dead-end 122 towards the right dead-end 120 (see FIG. 4). An embodiment of the control mechanisms may involve a linkage 146 for the airfoil section 140 and a linkage 154 for the airfoil section 142, which may be disposed along a hinge 150 in a direction generally perpendicular to the paper to enable independent movement of the sections 140 and 142. Alternatively, the airfoil sections 140 and 142 may be linked together by a single linkage as a single airfoil and may rotate together around the hinge 150 (not shown).

The two airfoil sections in FIG. 3 and FIG. 4 may not be the same or symmetric with respect to the joint mechanism 150; they may have different shapes or dimensions, depending on performance considerations or deployment of the lift or thrust system on a vehicle in conjunction with the corresponding reciprocating driver 106. Similarly, the joint mechanism 116, as well as the related center of rotation shown in FIG. 1 and FIG. 2, is for illustration convenience. The joint mechanism may a hinge or a three-dimensional joint such as a ball joint. The center of rotation may be located at the center of pressure of the airfoil 102 for structural consideration or other locations for performance or deployment consideration. Accordingly, the center of rotation of an airfoil may be located anywhere from the leading edge to the trailing edge of the airfoil. More generally, the airfoil may be rotated around a center of rotation that may be located at any location, on or off the airfoil, for airfoil structural, performance, or deployment consideration.

The concept of high-lift devices employing a leading-edge slat may also be adapted for the system of this invention. FIG. 4a shows schematically a reciprocating airfoil 140 incorporating a leading-edge slat 156 and a trailing-edge flap. When a retractable mechanism is difficult to be deployed, perforated holes, 157 and 158, are used to provide flow passages while retaining the integrity of the airfoil. The concept of the leading-edge flap or droop may also be implemented, but it is not shown herein. The configuration as shown in FIG. 3 and FIG. 4 may be similar to the configuration of a single-element trailing-edge flap in a fixed-wing aircraft. Multi-element trailing-edge flaps are also within the scope of this invention. As shown in FIG. 4a, because of the flow passages 158, the airfoil 140 may be viewed as a trailing-edge flap with two elements. More sophisticated multi-element trailing-edge flaps may be adopted, although they are not shown herein.

As mentioned before, the center of rotation for changing or maintaining the angle of attack may also be disposed at a location away from the airfoil. As shown in FIG. 5, an airfoil 102 integrated with optional supporting structures 110 may be rotated around a center of rotation 150, which is spaced away from the airfoil 102, for changing the angle of attack or maintaining a positive angle of attack for both the leftward and rightward strokes. In FIG. 5, the supporting structures 110 are disposed in a direction of the airfoil chord. However, they may also be deployed in the direction of the airfoil span. It should be noted that for the airfoil shown in FIG. 5, the two strokes in a cycle may produce different performance. The stroke that produces a better airfoil performance than the other is termed the primary stroke in this disclosure.

It is well understood in the arts that the control unit may have a broad functionality that could maintain a positive or negative angle of attack α as well as constantly change the magnitude of α for desired lift or thrust during operation. Additionally, α′ in FIG. 2 may be positive or negative and may have the same value as the α in FIG. 1, but it may also take a value different from the value of α. The embodiments 108 and 122 with the push or pull rods (or tubes) are for the convenience of illustration; other control units with only one rod or without a rod may also be employed. The embodiments, 108 and 122, could be two components of a single unit, but a control unit with a single component may also accomplish the same control functionality. One example is that the airfoil may rotate around its leading edge to turn an angle while a single rod or tube may be employed to actuate the turning. In general, the said control unit may be, but not limited to, a mechanical control unit, an electromagnetic control unit, an electrical control unit, or a hydraulic control unit.

Although the turning of the airfoil may be preferably actuated near the dead-end of the stroke, the actual turning motion may occur over the entire stroke, which is superposed to the linear motion component of the airfoil. As will be seen, a longer stroke could increase the average reciprocating speed, and a larger ratio of the stroke to airfoil chord would enhance the linear motion, which may be beneficial to the performance of the airfoil.

In the embodiments of this invention, the x-axis, shown in FIG. 1, is generally designated as the direction of the reciprocal motion of an airfoil, z designated as the direction perpendicular to the reciprocating motion, and y designated as the span direction of the airfoil. The geometric shape, construction, and materials of the airfoil may be similar to those of existing airfoils, such as those related to conventional aircraft, or may be adapted for better performance and reciprocating condition of this invention. For convenience, the combination of the airfoil, the supporting structure, such as 114 shown in the above figures, and the related control mechanism may be termed as an airfoil assembly in this disclosure. Because of the reciprocating motion of the airfoil assembly, significant inertia forces and related inertia moments may be generated. It is, therefore, essential that the mass of the airfoil assembly be minimized while maintaining its integrity and strength. Advanced modern wing construction techniques may be adapted in conjunction with lighter and stronger materials, including carbon fiber and other composite materials, to achieve maximum strength to weight performance of the airfoil assembly of this invention.

More than one airfoil assembly may be deployed in y or x-direction of the coordinate system shown in FIG. 1. Additionally, more than one airfoil assembly may be deployed in the direction of z. Each airfoil assembly may engage an independent reciprocating driver, but the deployed airfoil assemblies may also share a common reciprocating driver. FIG. 5a shows a schematic illustration of a sectional view of a reciprocating lift or thrust system with two airfoil assemblies, 102 and 102a, being disposed in a substantially vertical direction and sharing the same reciprocating driver 106. The two airfoils may be the same or different, and they may be rotated respectively around rotation centers 150 and 150a for setting, changing, or maintaining the angle of attack.

Similar to the reciprocating motion of a piston in a reciprocating compressor or reciprocating internal combustion engine, the speed of the airfoil, V, in a reciprocating lift or thrust system of this invention may vary between the two dead ends in a stroke, reaching a maximum speed between the two ends and a zero speed at each end. A useful velocity is a mean velocity in a stroke, V̅. Accordingly, a lift or thrust coefficient, C_{L} or C_{T}, may be defined based on this mean velocity:

F_{L}=C_{L}1/2 ρV̅²₂Aₚ (1)

F_{T}=C_{T}1/2 ρV̅²Aₚ (2)

wherein ρ is the density of the fluid and Aₚ is the planform area of an airfoil. The mean velocity is linked to reciprocating stroke Sand reciprocating frequency f (or reciprocating cycles per second) by the following relation:

V̅=2×S×f (3)

For a basic crankshaft related driver, S=2r, wherein r is the radius of the crank arm. A sufficiently long stroke or high frequency, or both, may produce a sufficiently high mean speed to provide a needed lift or thrust for a vehicle in conjunction with an acceptably large airfoil planform area.

Any reciprocating driver that may provide a sufficiently long reciprocating stroke or sufficiently high frequency is within the scope of this invention, which may be, but not limited to, a mechanical, electromagnetic, electrical, or hydraulic reciprocating driver.

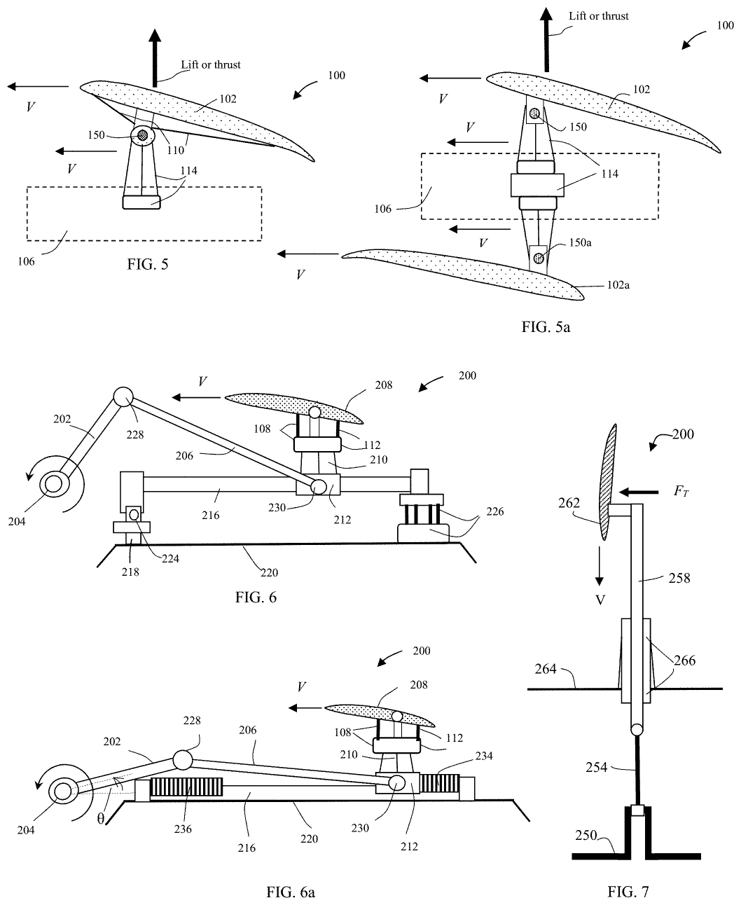

Said reciprocating mechanical driver maybe, but not limited to, a slider-crank mechanism driver, a cam-follower mechanism driver, a scotch yoke mechanism driver, a swashplate mechanism driver, or a wobble (Nutator or Z-crank) driver. FIG. 6 shows schematically an embodiment 200 of this invention with an airfoil 208 driven by a slider-crank mechanism driver. The airfoil 208 is driven by a crankshaft 204 through a crank arm 202 and a connecting rod 206. The crankshaft 204 in turn is driven by a power system (not shown). Through the connecting rod 206 as well as a supporting structure 210 that may include a roller or bearing structure 212, the rotation of the crankshaft 204 creates a reciprocating motion of the airfoil 208. Said roller or bearing 212 may be mounted on a track or guide structure 216, and slide, together with the airfoil 208, along the track 216. The track 216 may work as a guide for the reciprocating motion of the airfoil assembly 208 and carry loads of the lift or thrust as well as the weight of the airfoil assembly. The track 216 may take any shape or structure to accommodate the shape or structure of the roller or bearing 212, or may be simply a beam structure. The roller or bearing 212 may incorporate the rolling-slider or rolling bearing mechanism to minimize the friction between the slider and track. The present setting of the slider-crank mechanism may enable the airfoil 208 to undergo a reciprocating stroke on the order of meters for a higher reciprocating speed.

As an option for cyclic control of a vehicle of the present invention, said track 216 may be mounted on a section of a vehicle body 220 through a support 218 having a joint 224 and a control mechanism 226 that may tilt the track 216 in different directions. For example, at least one of the connecting rod joints, 230 or 228, as well as the joint 224, may accommodate multi-directional movements. Thereby, through the control mechanism 226, which may act independently from the pitch control mechanism 108 or 112, the track 216, as well as the reciprocating plane of the airfoil 208, may be tilted in desired directions for the purposes of cyclic control of vehicle flight. Together with other possible supports, the action of the control mechanism 226 and support 218 may also raise or lower the track structure 216 and the airfoil 208, relative to the vehicle body section 220. Alternatively, for the cyclic control purpose, the entire reciprocating lift or thrust system of this invention, including the reciprocating driver, may be tilted, raised, or lowered by related control mechanisms (not shown).

In some cases, however, the cyclic control mechanism, as described in FIG. 6, may not be feasible, and the track structure 216 may need to be directly assembled to the vehicle's main body. FIG. 6a shows schematically such a case in which the track structure 216 is directly fixed to a section of the vehicle surface for structural considerations. To minimize the weight penalty, the track structure itself may be preferably part of the backbone of the vehicle. Also, the lift or thrust system of this invention may be subject to significant inertia forces due to acceleration or deceleration of the airfoil assembly in each stroke, which could generate significant stresses in the structural members of the reciprocating driver. To mitigate this problem, spring coils may be employed to reduce the inertia force related stresses. FIG. 6a shows schematically such an embodiment, which employs two springs coils or spring coil assemblies containing a plurality of spring coils, 234 and 236. In the crank position measured by the crank angle θ shown in FIG. 6a, approximately within 0≤θ<90°, the airfoil assembly may accelerate and move from the right end toward the left end. In this case, the compressed spring coil 234 would expand, releasing the energy stored during the last stroke and pushing the airfoil assembly forward to reduce the stress of the driver members. Approximately within 90°<θ≤180° in the same stroke, the airfoil assembly may decelerate. In this case, the airfoil assembly would compress the spring coil 236 while the spring coil 236 receives an amount of energy from the airfoil assembly. Said energy would be used to push the airfoil assembly forward after the airfoil assembly changes the direction and moves from the left end toward the right end in the next stroke (not shown).

In FIG. 6 and FIG. 6a, the airfoil assembly is mounted on a track structure and slides along the track while the track is fixed to the body of a vehicle for structural consideration. In some applications where the working environment of an airfoil may need to be isolated from the reciprocating driver or the related power system, the airfoil assembly may be fixed to a beam structure and undergo a reciprocating motion with the beam. FIG. 7 shows schematically such a case employing a crankshaft related mechanical driver 250. Through a connecting rod 254, the reciprocating driver created a reciprocating motion of a beam structure 258. An airfoil assembly 262 is fixed to the beam 258 and reciprocates along with the beam. Said airfoil assembly 262 generates a thrust F_{T} while the outside environmental fluid surrounding the airfoil assembly is substantially isolated from the driver 250 through a partition 264. The beam 258 and the airfoil assembly 262 may be supported by a supporting structure 266 that may also work as a bearing or rolling guide and may include seals to minimize the leakage of the fluid from the outside of the partition 264 into the inside space. To reduce the inertia stresses of the reciprocating driver members, spring coils or spring coil assemblies may also be employed with the supporting structure 266 (not shown).

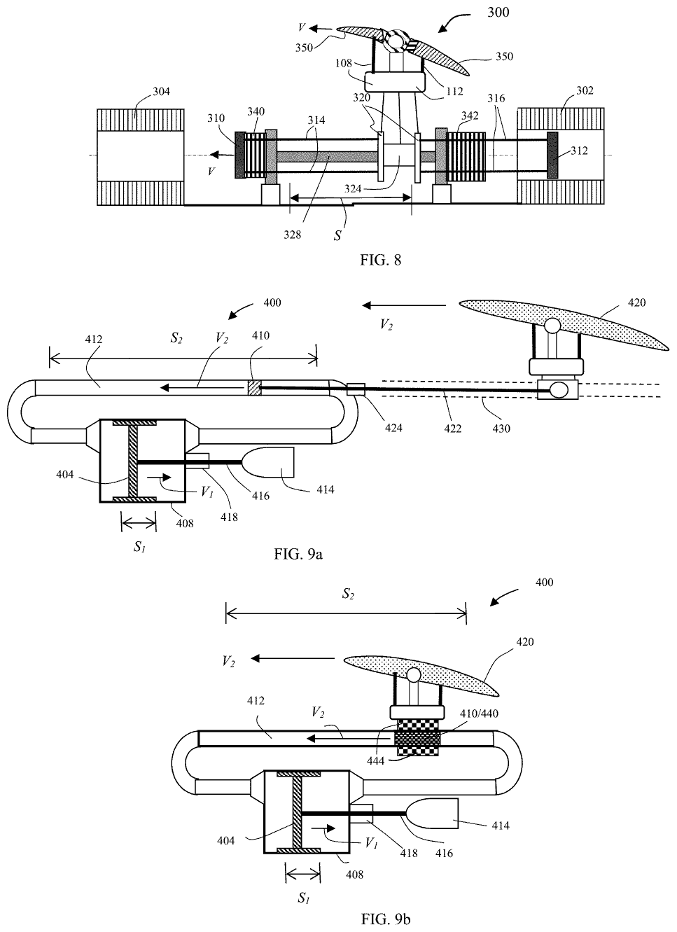

Another embodiment of the reciprocating driver is an electromagnetic driver. FIG. 8 shows schematically an embodiment 300 of the electromagnetic driver, employing a pair of electromagnets 302 and 304 and a pair of permanent magnets 310 and 312. Said electromagnets may be energized by a power source such as a battery system (not shown) of suitable current and voltage. In the case of FIG. 8, the polarity of the electromagnet is set in such a way that it repels the corresponding permanent magnet when the electromagnet is energized. Through connecting rods 314 and 316, said permanent magnets 310 and 312 are connected to an airfoil assembly 350 through supporting structures 320. Said supporting structure 320 includes a bearing or rolling slider 324 that may slide along a track 328. When the permanent magnet 312 is near the right dead end of a reciprocating stroke, the electromagnet 302 is energized, and the generated repulsive electromagnetic force pushes the permanent magnet 312 as well as the airfoil assembly 350 to the left, as shown in FIG. 8. When the permanent magnet 310 is near the left dead-end of the stroke, the electromagnet 302 would be de-energized, and the electromagnet 304 would be energized while the airfoil assembly is pushed from the left dead-end toward the right dead end (not shown). Spring coils or spring coil assemblies 340 and 342 may be employed to reduce the energy consumption of the driver. Referring to FIG. 8, when the airfoil assembly 350 moves from right to left, the compressed spring coil 340 associated with the permanent magnet 310 expands and pushes the airfoil 350 to the left. Before the permanent magnet 312 reaches its left dead-end in the stroke, the spring coil 342 would be compressed, and a substantial amount of the kinetic energy associated with the airfoil assembly as well as the permanent magnets may be stored as the potential energy by the spring coil 342. The stored energy would be released to help push the airfoil assembly to move from the left to the right in the next stroke (not shown).

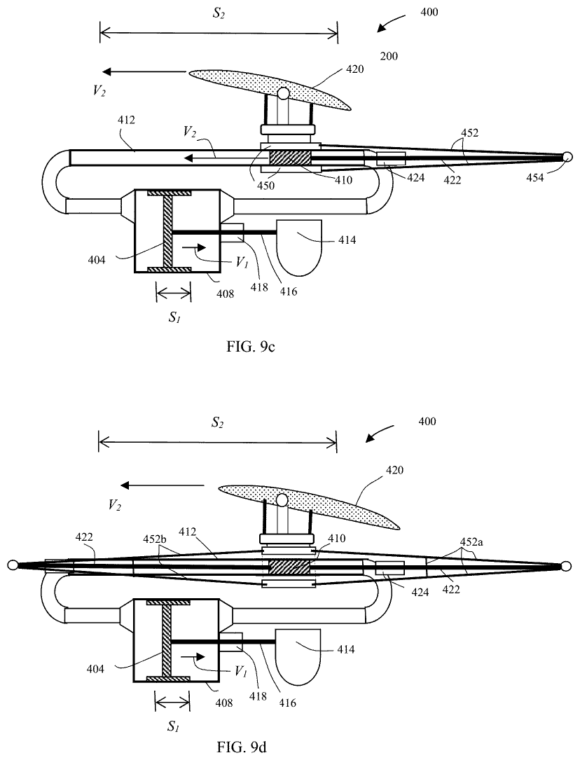

Yet another embodiment of the reciprocating driver is a hydraulic driver. FIG. 9a shows a schematic illustration of an embodiment 400 of a hydraulic driver, with the purpose of magnifying the reciprocating stroke of an airfoil assembly. Said hydraulic driver includes a loop filled with a fluid, such as, but not limited to, oil or water, a larger piston (or partition), and a smaller piston (or partition) disposed within the loop. Because of the piston sealing functionality and the near incompressibility of the liquid, a smaller reciprocating stroke of the larger piston may generate a larger reciprocating stroke of the smaller piston, thereby increasing the reciprocating stroke of the associated airfoil assembly. Referring to FIG. 9a, a larger piston 404 is installed in a chamber 408 having a cross-sectional area of A₁, and a smaller piston 410 is installed in a loop section 412 having a smaller cross-sectional area A₂. Said larger piston is driven by a reciprocating driver 414 through a connecting rod 416 and a seal 418. Said reciprocating driver 414 may be, but not limited to, a slider-crank mechanism driver, a cam-follower mechanism driver, a scotch yoke mechanism driver, a swashplate mechanism driver, a wobble (Nutator or Z-crank) driver, an electromagnetic driver, or an electrical driver such as a linear actuator. The smaller piston 410 is connected to an airfoil assembly 420 through a connecting rod 422 and a seal 424. Because of the near incompressibility of the liquid enclosed within the chamber 408 and the other loop sections, the ratio of the stroke of the airfoil assembly 420 (or the stroke of the smaller piston 410), S₂, to the stroke of the reciprocating driver 414 (or the stroke of the larger piston 404), S₁, may be approximately proportional to the ratio of A₁ to A₂:

$$\frac{{S}_{2}}{{S}_{1}} ∝ \frac{{A}_{1}}{{A}_{2}}$$

For example, if the area ratio above is over 10, the airfoil stroke may be increased by more than ten times as compared to the stroke of the reciprocating driver 414. To reduce the force load of the driver, the airfoil assembly 420 may be supported by a track 430, as in the case for some other reciprocating drivers disclosed. For a small and light airfoil assembly, the airfoil assembly 420 may be carried by the connecting rod 422 without a track (The same is true for other disclosed reciprocating drivers). When the stroke of the reciprocating drive 414 is small or moderate, the seal 418 may be a bellows that could be leakage free. Additionally, the seal 424 may be replaced by a bellows or a bellows assembly (not shown). To reduce the friction related to the pistons and seals, a rolling slider or rolling bearing mechanism may be employed.

Alternatively, the connecting rod 422, the seal 424, and the track 430 in FIG. 9a may be eliminated, and the airfoil assembly 420 may be directly disposed on section 412 of the loop and slide along section 412 with the smaller piston 410. For example, as shown in FIG. 9b, the smaller piston may be substantially a magnetic material 440, and the airfoil assembly 420 is attached to a magnet 444 of unlike poles, which is mounted outside of the loop section 412 and is attracted to the magnet 440. As the magnet piston 440 moves reciprocally inside the loop, the external magnet 444, as well as the airfoil assembly 420, may move along with the magnet 440, creating a reciprocating motion of the airfoil assembly 420. The magnets 444 and 440 may be permanent magnets or electromagnets depending on specific designs and applications. One of the advantages is the compactness of the system. Similar to other reciprocating drivers disclosed, spring coils or spring coils assemblies may be employed inside of or outside of the liquid loop, as well as for any suitable reciprocating driver 414 to reduce the stresses of reciprocating members (not shown). In particular, for the case in FIG. 9b, spring coils, or spring coil assemblies, may be disposed outside of the loop section 412 to reduce the inertia force load and to prevent magnet 444 from sliding away from the location of the magnet 440 (not shown).

Yet another alternative hydraulic driver is to directly mount the airfoil assembly on the smaller piston related loop section that acts as a guide for the airfoil assembly by employing truss structures. Referring to FIG. 9c, through a bearing or roller slider structure 450, the airfoil assembly 420 is directly mounted on the outside surface of the loop section 412 that is supported by a section of the vehicle (not shown). A truss structure 452 (front or back, or both front and back) with the connecting rod 422 links the smaller piston 410 with the airfoil assembly 420, thereby a reciprocating motion of the airfoil assembly 420 is generated by the reciprocating motion of the smaller piston 410. A joint 454 that links the connecting rod 422 and the truss structure 452 may permit independence between the dimensional tolerance of the smaller piston 410 with the inner surface of the loop section 412 and the dimensional tolerance of the bearing or roller structure 450 with the outer surface of the loop section 412.

Yet another alternative hydraulic driver is to directly couple the motion of the smaller piston with that of the airfoil assembly without a sliding motion of the airfoil assembly on the outer surface of the smaller-piston related loop section. Referring to FIG. 9d, bearing 450 in FIG. 9c is eliminated. The airfoil assembly is supported by the inner surface of the loop section 412 through truss structures 452a and 452b together with the connecting rods 422 and the smaller piston 410, while undergoing a reciprocating motion with the smaller piston.

Within the loop and outside of the loop of the hydraulic driver, frictional heat may be generated due to the friction between the piston/connecting rod and the inner wall of the loop, as well as the friction between bearing and the outer surface of the loop. Fins or heat pipes may be disposed at some locations of the loop, and the loop fluid may be cooled through natural convection or forced convection through a fan. Additionally, a liquid compensation mechanism may be installed to accommodate certain thermal expansion or contraction as well as a small amount of fluid leakage through the seals over a time period to ensure the loop integrity and the loop be completely filled with the liquid.

It is understood that the inertia forces and moments generated by the reciprocating airfoil assembly and the reciprocating driver need to be balanced to avoided significant system vibration. It is also well established in the reciprocating engine or compressor industries that the use of an even number of pistons combined with proper piston and crank arrangements may be able to significantly cancel out the related inertia forces and moments. The well-known piston-cylinder geometries may include, but not limited to, in-line, horizontally opposed, opposed-piston, V-shaped, and radial arrangements. For the reciprocating driver of this invention using a crankshaft, the counterpart of the piston and cylinder combination is the combination of the airfoil assembly and track, as shown in FIGS. 6 and 6a. When the airfoil assembly is fixed to a beam and moves along with the beam, the counterpart of the piston and cylinder combination is the combination of the beam-airfoil assembly and the guiding structure for the beam, as shown in FIG. 7. Accordingly, the arrangements and balancing methods taught by reciprocating engine or compressor industries are all within the scope of this invention.

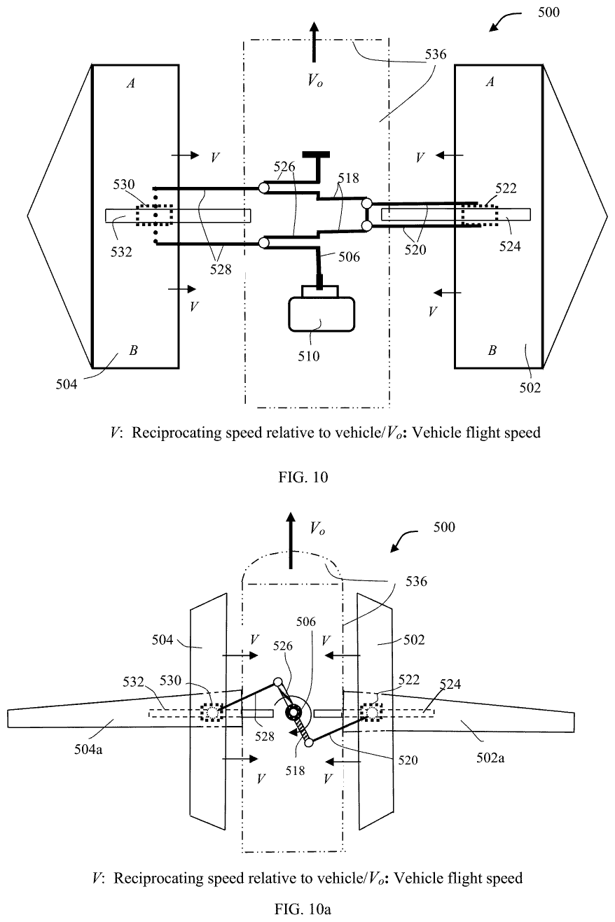

FIG. 10 shows a schematic, top view of a crankshaft and airfoil assembly arrangement 500, with a preferred opposed arrangement, to minimize or eliminate the requirement for crankshaft counterweights. Referring to FIG. 10, two airfoil assemblies, 502 and 504, reciprocate in a lateral or transversal direction of the vehicle and are disposed respectively on the two sides of a crankshaft 506, which is driven by a power system 510. Cranks 518, connecting rods 520, roller structure 522, and related track structure 524 for airfoil 502; and cranks 526, connecting rods 528, roller structure 530, and related track structure 532 for airfoil 504 are also shown in the figure. Although one track for each airfoil assembly is shown in FIG. 10, more than one track for each airfoil assembly may be deployed.

In FIG. 10, the airfoil assembly 502 moves from the right to the left in a stroke while the airfoil 504 moves from the left to the right in a stroke, and both airfoil assemblies are moving towards the crankshaft 506 with velocities V of almost identical magnitude but in opposite directions. Since the two airfoil assemblies, as well as their associated cranks and connecting rods, are substantially identical, inertia forces and moments created by the acceleration or deceleration may be substantially canceled out with this arrangement. One skilled in the art may recognize that only two airfoil assemblies are displayed in FIG. 10, but additional airfoil assemblies and related crank mechanisms may be added to the crankshaft 506 to accommodate lift or thrust needs or for more complete cancellation of the inertia forces and moments. One skilled in the art may also recognize that due to air downdraft, the center of the airfoils may be sufficiently away from the planform 536 of a vehicle's main body to avoid significant downdraft blockage by the top surface of the aircraft body. The reciprocating airfoil may take any shape, not just the shape of the schematic illustration in FIG. 10, for performance, aerodynamic, and structural considerations. To take advantage of the airflow across the airfoils because of the cruise speed of Vₒ for additional lift generation, the airfoil in the direction of A-B may be shaped like an airfoil having a positive angle of attack with respect to the airflow across the airfoil in the direction of A-B.

It should be mentioned that the crankshaft related reciprocating driver shown in FIG. 10 may be replaced by a different reciprocating driver, such as, but not limited to, a different kind of mechanical driver, an electromagnetic driver, an electrical driver, or a hydraulic driver. For some applications, a crankshaft and airfoil-assembly arrangement other than the opposed arrangement shown may also be employed.

The reciprocating lift system of this invention may be deactivated or work at a low reciprocating speed to reduce energy consumption and increase flight range if fixed wings are available to generate lift during the cruise. Additionally, in FIG. 10, the crankshaft is deployed generally parallel to the vehicle's main body, which may need to raise the reciprocating driver as well as the airfoil assembles to a sufficiently high level above the top surface of the vehicle body (or below the bottom surface of the body when the airfoils are deployed below the vehicle's main body) to accommodate the rotation of the cranks. For a relatively large reciprocating stroke that demands a relatively large radius of crank arms, this arrangement may cause aerodynamic losses and structural concerns.

Referring to FIG. 10a, a crankshaft 506 is deployed in a direction generally perpendicular to the vehicle's main body with two cranks 518 and 526 being disposed along the crankshaft 506 in the perpendicular direction, under an opposed arrangement. The cranks 518 and 526, through connecting rods 520 and 528, respectively, drive airfoil assemblies 502 and 504. The airfoils assemblies, including rollers 522 and 530, are respectively guided by tracks 524 and 532 that are integrated with and supported by fixed wings 502a and 504a, respectively. Like the case in FIG. 10, both airfoil assemblies 502 and 504 reciprocate in a lateral direction with almost identical velocity magnitude but in opposite directions to significantly cancel out inertia forces and moments. The vehicle flight speed Vₒ is also shown in FIG. 10a. During takeoff or landing, Vₒ is almost zero, and lift or thrust is generated almost exclusively due to the reciprocating motion of the airfoils. But during the cruise at a relatively high speed, the fixed wings 502a and 504a may generate lift through the flight speed of the vehicle, in addition to that generated due to the reciprocating motion of the airfoils 502 and 504. If the fixed wings 502a and 504a can generate sufficiently high lift, the airfoils 502 and 504 may stop reciprocating or reciprocate at a low speed to conservation energy. Similar to the situation in FIG. 10, the airfoils 502 and 504 may have a positive angle of attack with respect to the airflow associated with the vehicle's flight speed, which flows across the airfoil in the front-back direction and enhances the lift of the airfoil. Alternatively, if no other thrust means is equipped in the vehicle, the reciprocating airfoils 502 and 504 may tilt forward to provide thrust for the flight. The combination of the reciprocating and fixed wings in FIG. 10a also has certain structural merits as the fixed wings 502a and 504a are essentially the tracks for the reciprocating wings 502 and 504. Although one track for each airfoil assembly is shown in FIG. 10a, more than one track for each airfoil assembly may be deployed.

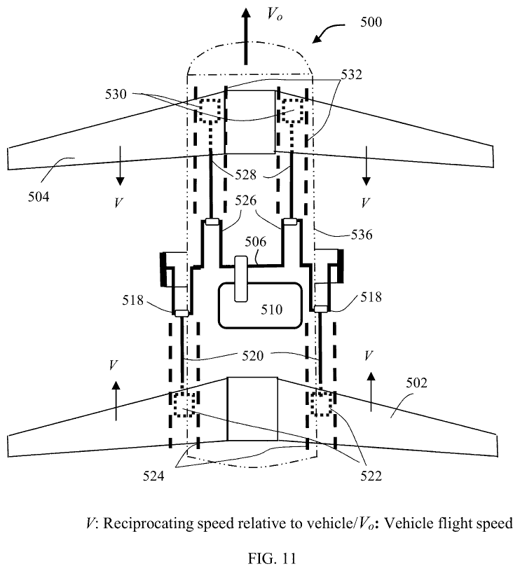

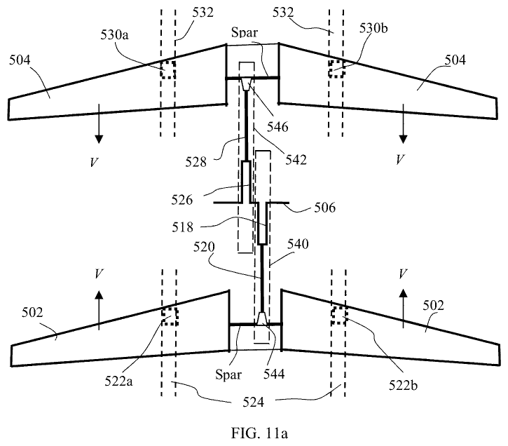

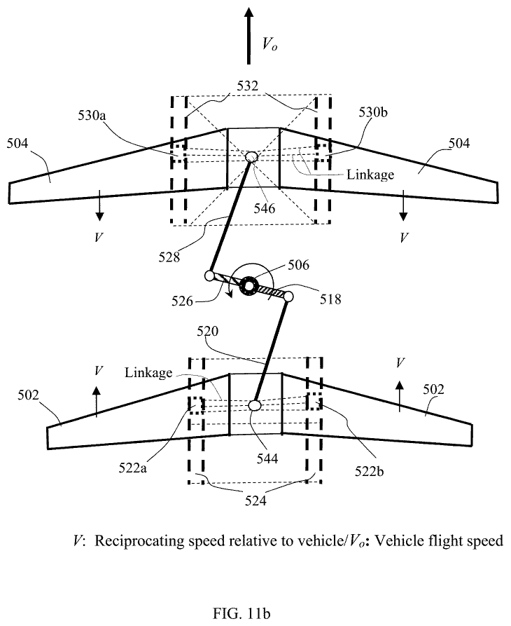

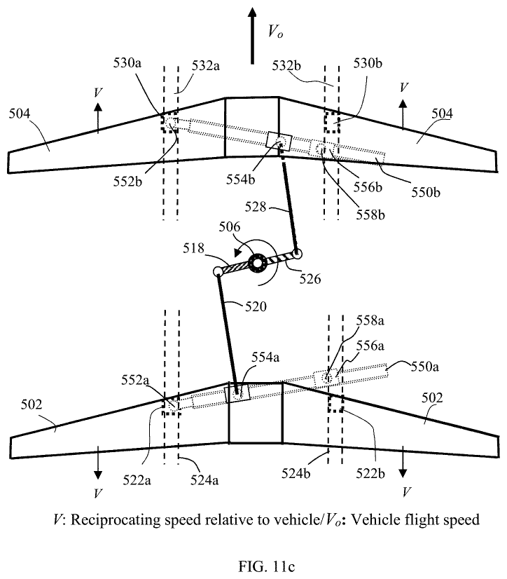

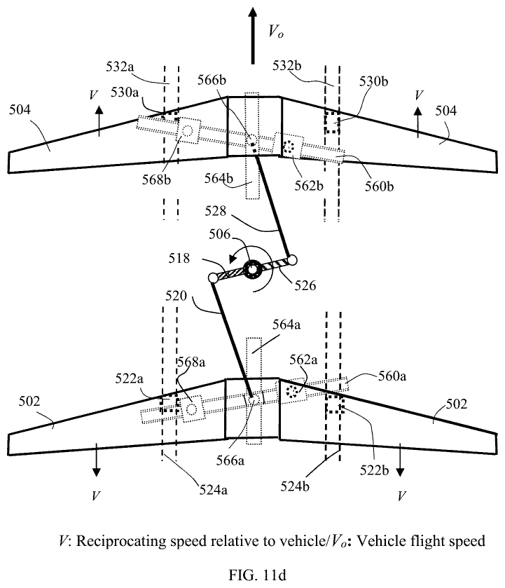

The airfoils may also reciprocate in a front-back direction of the vehicle to more effectively take advantage of the airflow across the airfoils during the cruise for lift generation. Referring to FIG. 11, two airfoils, 502 and 504, are shaped like the wings of a fixed-wing airplane and are deployed substantially in a front-back direction of the vehicle with an opposed arrangement, in which both airfoils, as a pair, reciprocate in a longitudinal direction of the vehicle with almost the same velocity magnitude but in opposite directions for the balancing purpose. During takeoff or landing when the vehicle cruise speed is zero, this deployment may benefit from the longer airfoil span perpendicular to the reciprocating motion for a higher lift-to-drag ratio. During the cruise, the vehicle flight speed is superposed with the reciprocating speed, which creates a substantially higher effective velocity across the airfoils. This substantially increased effective velocity would at least benefit the primary strokes of the airfoils for a significantly increased lift. The cranks 518 for the airfoil 502 and the cranks 526 for the airfoil 504 are driven by a crankshaft 506. The related connecting rods 520 and 528, rollers (or bearings) 522 and 530, and tracks 524 and 532 are also shown in the figure.

The airfoil deployments, as shown in FIG. 10, FIG. 10a, and FIG. 11, all involve at least a pair of airfoils with substantially neutralized inertia forces and moments. This pair of reciprocating airfoils may be referred to as a reciprocating airfoil (RA) module or an RA cell. For the operation of a vehicle, one or more such an RA module may be deployed at any suitable location and reciprocates in any preferred direction, driven by the same mechanism or separate mechanisms. The reciprocating direction or the reciprocating plane of the RA module may be raised, lowered, or tilted in any direction as needed by control mechanisms.

As discussed before, the deployment of the crankshaft generally parallel to the vehicle's main body surface may need to raise the lift system or airfoils to a sufficiently high level above the body surface, which could incur additional aerodynamic losses under high-speed flight. To mitigate this problem, recesses may be created in the vehicle body, which may accommodate the rotation of the cranks without raising the lift system as well as the airfoil assemblies to an undesirable level. Referring to FIG. 11a, a recess 540 is created for the airfoil 502 while a recess 542 is created for the airfoil 504. Also, in this deployment, a crank and connecting-rod combination located at a midsection of the airfoil is employed to drive each airfoil assembly through a linkage mechanism 544 or 546. The linkage may engage a spar that runs through the airfoil. One skilled in the art may recognize that it may be difficult to completely cancel out inertia forces or moments under desired component arrangements in a reciprocating system. However, some conventional ways, such as adding or removing some masses at different locations, may help. For example, a small amount of mass A may be added on the left part of the airfoil assembly 502, while the small amount of mass B is added on the right part of the airfoil assembly 504. Through the adjustment of the amount of the mass as well as the perpendicular distance between these two masses, some unwanted inertial moments may be balanced.

Alternatively, similar to the case in FIG. 10a, the crankshaft may be deployed in a direction generally perpendicular to the main-body surface of a vehicle. Referring to FIG. 11b, a crankshaft 506 is deployed in a direction generally perpendicular to the vehicle body with two cranks 518 and 526 being disposed along the perpendicular direction of the crankshaft with an opposed arrangement. The cranks 518 and 526, respectively, drive airfoil assemblies 502 and 504 that are shaped like wings of fixed-wing airplanes, through connecting rods 520 and 528, respectively. The deployment, as shown in FIG. 11b, is especially beneficial for high-speed vehicles. Because the spacing between the two cranks, 518 and 526, in the vertical direction can be limited, the entire lift system including the airfoil assemblies, may be disposed sufficiently close to the surface of the vehicle body. With relatively short fairing, the effect of the cranks and connecting rods on the aerodynamic losses may be minimized. Additionally, the elevation difference between the front and rear airfoils may be flexibly adjusted, which may be beneficial for the formation of a combined, fixed wing during the high-speed cruise. In the configuration of FIG. 11b, the two rollers for each airfoil are integrated through a linkage mechanism, and the airfoil is driven through the connecting rod engaging the linkage mechanism. Also, the vehicle backbones may be used as the track structures that are interconnected through some truss structures for enhanced integrality.

The average reciprocating speed of the present reciprocating system is directly proportional to the reciprocating stroke. A longer stroke may have the potential to reduce the reciprocating frequency for a given average reciprocating speed, which is particularly important for inertia force reduction and structural consideration. However, a longer stroke would demand a longer crank radius, which in turn could cause higher inertia stresses in reciprocating members. Therefore, there is an incentive to increase the airfoil reciprocating stroke without increasing the crank radius. A slotted bar/slider mechanism taught and demonstrated by Thang010146 [1] is adapted for the present invention, although the slotted bar may be replaced by a non-slotted bar or a tube. FIG. 11c shows schematically a crankshaft-driven RA module that employs two slotted bars, 550a and 550b, to increase the stroke of the airfoils over that without the slotted bars. To illustrate the working mechanism, the functionality of the slotted bar 550a, which engages a roller 522a through a joint 552a to drive the airfoil assembly 502, is considered. The slotted bar 550a is, in turn, driven by the connection rod 520 of the crank 518 through a slider 554a mounted on the bar. Further to the right, another slider 556a is disposed on the bar. The slider 556a has a revolution joint 558a that pivots the slider 556a and would allow the slider 556a to rotate around the joint 558a. When the airfoil assembly 502 moves toward an end of the track 524a, as indicated by the velocity V in FIG. 11c, the slotted bar 550a could accordingly accommodate a longer traveling distance of the airfoil assembly along the track, through a combined motion of sliding through the slider 556a and rotation around 558a, so that the stroke of the airfoil is increased. The stroke of the airfoil may also be adjusted by changing the position of the slider 556a with the revolution joint 558a. It should be mentioned that although in FIG. 11c the slotted bars drive the airfoil assemblies through the rollers 522a and 530a, they may engage any suitable locations of the airfoil assemblies to drive the airfoils.

Another slotted bar/slider mechanism taught and demonstrated by Thang010146 [2] is adapted herein, which is similar to the one used in FIG. 11c, but the slotted bar is driven by the crankshaft along a fixed track, and also the slotted bar may be replaced by a solid bar that slides through a rotatable slider. FIG. 11d shows schematically a crankshaft-driven RA module that employs two bars, 560a and 560b, which are driven by connecting rods, 520 and 528, respectively, along two fixed tracks 564a and 564b. To illustrate the working mechanism, the bar 560a that engages an airfoil 502, is considered. Referring to FIG. 11d, a pivoted slider 568a, which is mounted on the bar 560a and would permit the bar to slide through, engages the airfoil 502 at an airfoil section to drive the airfoil along its tracks 524a and 524b. Further to the right, a pivoted slider 562a is disposed on the bar. Through its connecting rod 520, a crank 518 drives the bar 560a through an engagement joint 566a along a fixed track 564a, creating a reciprocating motion of the bar along the track 564a. Through the combined motion of sliding and rotation of the system, the stroke of the airfoil could be doubled or tripled compared to that without the bar. Furthermore, adjusting the pivoting position of slider 562a could change the stroke of the airfoil. To reduce the friction related to the slotted bar, rolling mechanisms between sliding interfaces may be employed. The tracks 564a and 564b, as shown in FIG. 11d, are deployed near a midsection of the airfoils. However, they may be disposed in other suitable positions, and in particular, they may be combined with the tracks for the airfoils and share the same backbones of the vehicle. In addition to the techniques of increasing stroke herein, another well-known mechanism involving a fixed rack gear and a movable rack gear may be potentially employed to double the stroke of the airfoils for the present application.

FIG. 11e shows two RA modules that are disposed in a longitudinal direction of the vehicle while reciprocating in a forward-backward direction, driven by a crankshaft mechanism. In this case, airfoils 570 and 572 form a first RA module driven by a crankshaft 574, which is driven by a drive shaft 506 through a transmission means or a gearbox 576. Airfoils 580 and 582 form a second RA module driven by a crankshaft 584, which is driven by the same drive shaft 506 through a transmission means or a gearbox 586. For simplicity, the related connecting rods, rollers (or bearings), and tracks are lumped into 578 and 588, respectively, for the two modules. To reduce the distance between the airfoils and the vehicle's top main-body surface, both 578 and 588 could be disposed off the planform area of the vehicle, or crankshafts generally perpendicular to the top surface, like those seen in FIGS. 10a and 11b, can be employed. It is understandable that compared to a fixed airfoil, the size of a reciprocating airfoil may be limited due to the related inertia forces associated with the airfoil reciprocating motion. However, with the concept of the RA module, several relatively smaller RA modules may be deployed at different locations to drive a relatively large, heavy vehicle or for more completely balancing the inertia forces and moments for the vehicle. It is also understandable that the crankshaft drivers may be replaced by non-crankshaft drivers. In this case, the timings and relative locations of the related reciprocating members of the reciprocating drivers or driver sections, such as the moving permanent magnets in FIG. 8 and the pistons in FIGS. 9a-9d, may be carefully arranged for more complete cancellation of the inertia forces and moments.

An RA module reciprocating in a front-back direction may be able to take advantage of the vehicle's flight speed for a higher lift. However, the aerodynamic interaction of the two airfoils may be a concern. It is well known in the field that trailing vortices are a serious issue to be considered. As discussed earlier in the summary of this disclosure, the reciprocating motion of the airfoil could minimize this effect. However, in high-speed flight, when the reciprocating motion is deactivated and the airfoil would act as a fixed wing, this issue may need to be addressed particularly for the rear airfoil in an RA module. One approach is to maintain a shorter distance between the two airfoils or dispose the rear airfoil at a lower elevation to form a combined wing with the frontal one when the RA module works in a fixed-wing mode. Another approach is to make the span of the rear airfoil shorter than that of the frontal one. As seen in FIG. 11e, the span of airfoil 572 is shorter than that of airfoil 570. The airfoil 572, however, would still have the same equivalent mass as that of the airfoil 570 for balancing inertia forces and moments. Also, the second module involving airfoils 580 and 582 may be disposed at a higher elevation than the first module to reduce the vortex effect of the frontal module. Still, if the approaches above may not work satisfactorily, the airfoils may continue to reciprocate, albeit at a slower speed, to minimize the trailing vortex effect under high-speed cruise. Additionally, for compact vehicles with limited airfoil areas or short spans, the airfoil may continue its reciprocating mode through the entire flight range, but at a slower speed when the flight speed is relatively high.

In general, an RA module may be formed with two airfoils having substantially different shapes or different performance. The strokes, as well as related crank radii and connecting rod lengths of the two airfoils, may also be different, and the airfoil that produces a higher lift or thrust may be termed as the primary airfoil of the RA module. In a special situation, one of the airfoils in the module may be replaced by a non-airfoil body. In this case, the RA module becomes a single airfoil with counterweights, and sufficiently high lift or thrust may still be produced. Similar to a fixed-wing aircraft with foldable wings, the airfoils in the system of this invention may be folded when the vehicle travels on the ground. In the above embodiments of the RA modules, both airfoils in the RA are seen to be driven by the same reciprocating driver. However, the two airfoils in the module may be disposed at different locations and driven by two different drivers. With the motion of the same magnitude but in opposite directions, the related inertia forces and moments may still be canceled out. The use of a larger number of smaller sized RA modules may not always be feasible, but the arrangement could minimize potential lift fluctuation at the low reciprocating frequency by setting different modules with different reciprocating speeds at a given time.

The airfoils in FIG. 10 through FIG. 11e are driven by a power system, such as 510 shown in the above figures. Said power system may be, but not limited to, an internal combustion engine, a gas turbine engine, an engine driven by a pressurized gas from a storage tank, an electromagnetic force driven engine, a combination of an electric motor and fuel cell stacks, an electric motor, a battery pack, or an electric generator. Having described working principles and certain embodiments of the reciprocating lift and thrust systems of this invention, their applications to several transportation systems are disclosed.

### Aircraft

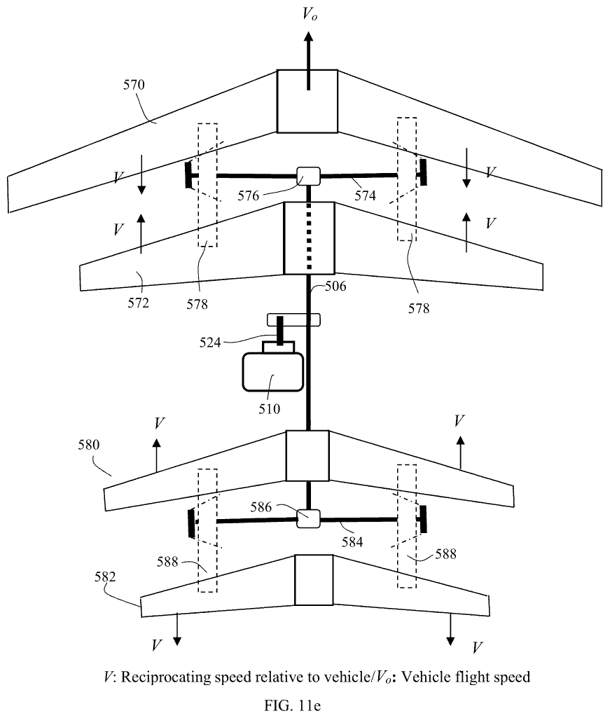

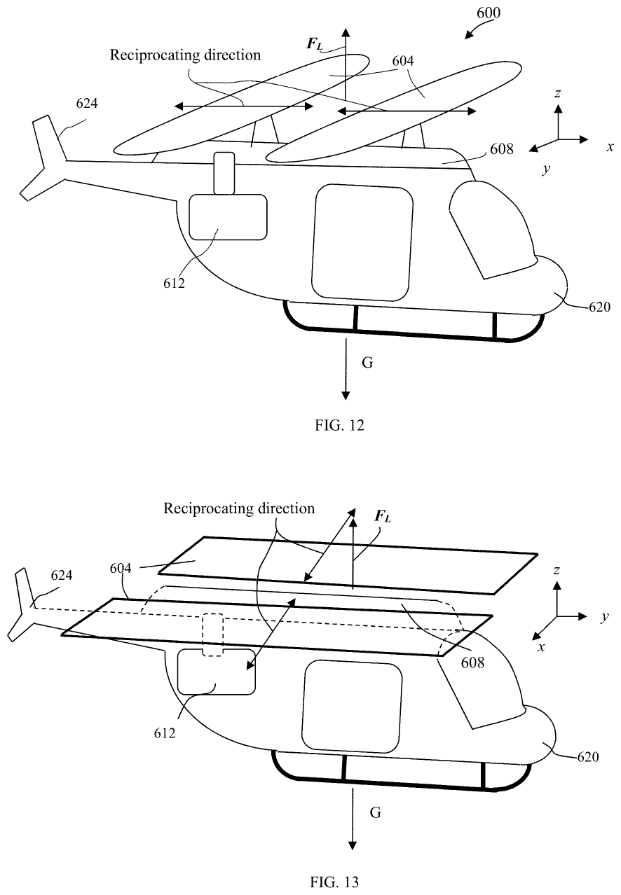

The lift or thrust system of this invention may create a new category of vertical takeoff and landing (VTOL) aircraft. As an embodiment, the lift or thrust system of this invention may replace the rotary-wing in a helicopter to create aircraft that can take off and land vertically, hover in the air, and easily maneuver without relying on the complex rotary lift system. Because of the higher lift-to-drag ratio of the reciprocating airfoil (or reciprocating wing), the aircraft thus created may operate with much higher energy efficiency and increased flight range. FIG. 12 shows a schematic view of an aircraft 600 that employs an RA module comprising two airfoil assemblies 604 driven by a reciprocating driver system 608, which in turn is driven by a power system 612, during takeoff, landing, or hovering in the air. In this case, the reciprocating direction or plane of the airfoil assemblies 604 may be oriented substantially horizontally, while undergoing a reciprocating motion in a longitudinal direction of the aircraft similar to the cases in FIG. 11-FIG. 11e. Like the cases in FIG. 10 and FIG. 10a, the airfoil assemblies may also reciprocate in a direction generally parallel to a lateral direction of the aircraft, as shown in FIG. 13. In accordance with the coordinate designations in FIG. 1 of this disclosure, y generally designates the span direction of the airfoil while x designates its reciprocating direction. The airfoils 604 work as wings and produce a lift F_{L} that would counterbalance the weight and payload of the aircraft, G. For simplicity, the airfoil in the figures is a schematic view that signifies its reciprocating direction or plane, without showing detailed configuration, control mechanisms, or the change of angle of attack during the reciprocating motion. One skilled in the field may recognize that although the airfoils reciprocate in a lateral or a longitudinal direction, the airfoils may reciprocate in any suitable direction to generate needed lift. In the aircraft shown in FIG. 12, any suitable airfoil-driver arrangement, such as those in FIGS. 11-11e, may be employed; and in FIG. 13, any suitable airfoil-driver arrangement, such as those in FIGS. 10 and 10a, may be deployed. In these two figures, as well as the following figures, more than one RA module may also be deployed.

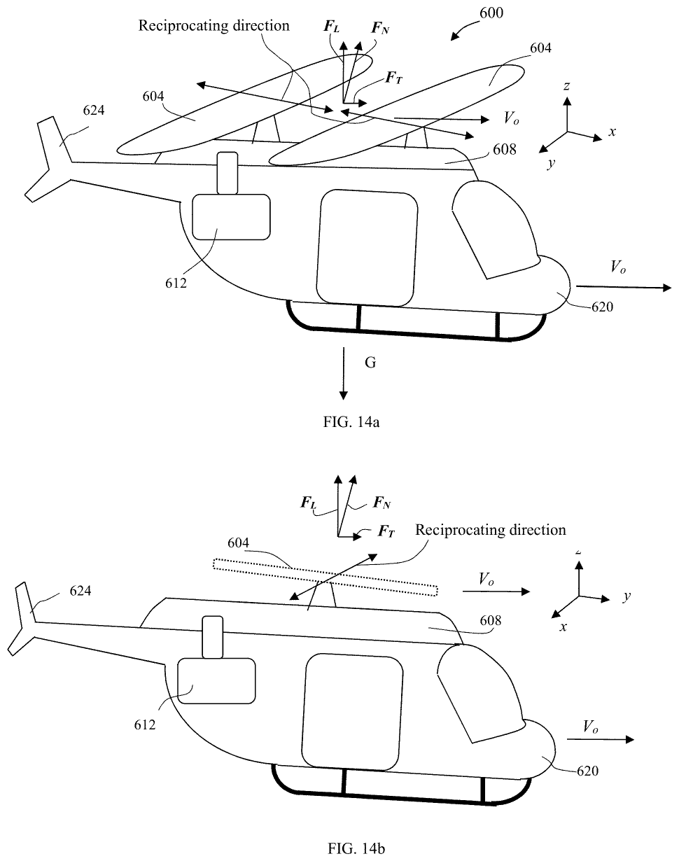

Like the cyclic control of a helicopter, the airfoil assemblies 604 may be tilted in the desired direction through a control mechanism such as those in earlier embodiments to produce thrust in that direction. As shown in FIG. 14a and FIG. 14b, the aircraft 600 flies forward in a direction designated by V₀, and the airfoil assemblies 604 tilt in that direction, producing both a lift F_{L} and a thrust F_{T} in the forward direction. In the case shown in FIG. 14a, the reciprocating direction or reciprocating plane of the airfoils is also tilted accordingly. However, in the case shown in FIG. 14b, the reciprocating direction of the airfoils remains the same.

Similar to the forward flight, the aircraft may fly backward, right sideward, or left sideward, by tilting at least an airfoil assembly in the respective direction (not shown). The tilting of an airfoil assembly backward may also produce an air braking effect to slow down the aircraft (not shown). The heading control may also be realized by tilting at least an airfoil assembly. For example, tilting a rear airfoil in the left sideward direction may cause the nose 620 of the aircraft to yaw to the right (not shown). The tilting of an airfoil assembly may be realized by tilting its reciprocating track as discussed earlier in this disclosure, tilting a planform that includes the airfoil assemblies and the reciprocating drivers, or tilting a planform that includes the airfoil assemblies and the reciprocating drivers as well as the associated power system. However, the airfoil tilting may also be realized without involving the above actions, as will be illustrated in later embodiments.

Alternatively, cyclic control functions, as well as heading control, may be realized through compressed air jets without involving complex control mechanisms. A thrust module such as a fan may also be employed for some of the cyclic control actions (not shown).

As the operation of the aircraft changes from the takeoff to cruise, a unidirectional airflow with a magnitude of the aircraft's flight speed is superposed to the motion of the reciprocating airfoil, which may increase the lift of the aircraft above that needed for takeoff, particularly when the primary stroke of the airfoil is in the same direction of the aircraft's flight. In this case, the power consumption of the aircraft during the cruise may be reduced by either reducing the angle of attack of the airfoil or by reducing the average reciprocating speed of the airfoil, which may be accomplished by decreasing the rotating speed of the crankshaft when a crankshaft mechanism is employed. Furthermore, at a sufficiently high aircraft flight speed, the control unit of the airfoil may be deactivated, which may have a benefit of increasing the reliability of the aircraft. Eventually, the airfoils may stop reciprocating and function as fixed wings.

In the flight conditions shown in FIG. 14a and FIG. 14b, both lift and thrust are provided by the reciprocating airfoils with or without the aid of fixed wings. Alternatively, the airfoils may primarily produce lift while a separate thrust system is used to provide the needed thrust. The related operations may include the following three modes: A. Once the aircraft is in the air and reaches a sufficiently high speed, the airfoil assemblies may switch the operational mode and work as fixed wings to produce lift without a reciprocating motion if a thrust means is incorporated into the aircraft. When a runway for takeoff and landing is available, the aircraft of this invention may also take off and land like a fixed-wing aircraft; B. During the entire flight, the airfoils reciprocate to provide lift while a thrust means provides the thrust; and C. Similar to the operation of mode A with the airfoils being arranged to produce lift using the cruise speed of the aircraft, but the airfoil maintains the reciprocating motion, albeit at a slower speed or smaller angle of attack, to provide additional lift, while a thrust means provides the thrust. When a runway for takeoff and landing is available, the aircraft under this mode may operate as a short takeoff and landing (STOL) aircraft, wherein the lift provided by the reciprocating airfoil enables an aircraft to take off and land on a short runway.

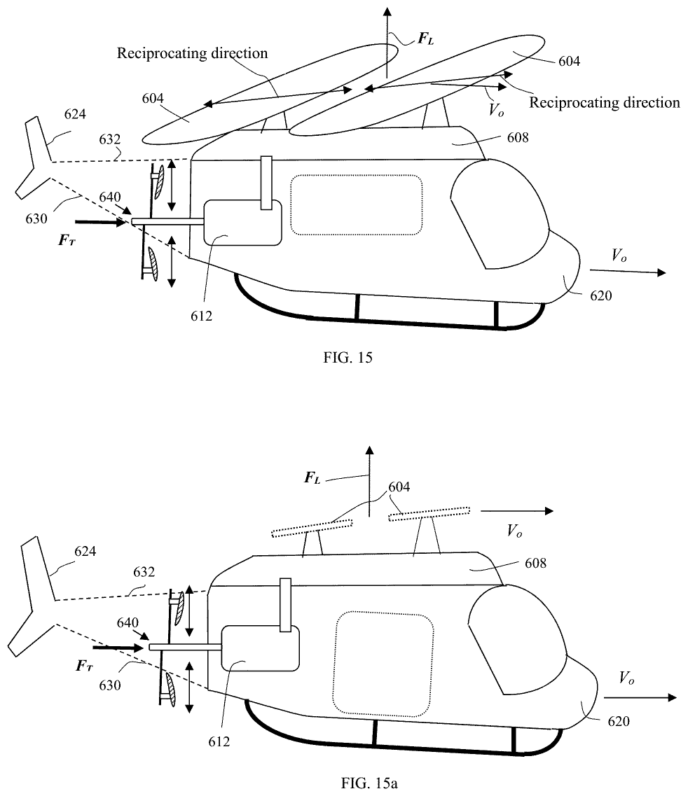

FIG. 15 shows schematically the embodiment wherein the airfoil assemblies 604 work to produce lift, while a thrust means, such as a reciprocating thrust system 640 of this invention, is employed to produce thrust F_{T} to push the aircraft forward. With the thrust from the thrust system 640, the airfoil assemblies 604 may be arranged in such a manner that they form a larger fixed-wing assembly with a desired effective positive angle of attack to use aircraft's flight speed to produce needed lift for the aircraft. During the cruise, the airfoil assemblies may stop reciprocating to work as fixed wings (Mode A) or continue reciprocating motion (Mode B or C), as shown in FIG. 15. The two airfoil assemblies 604 may also move as close as possible to reduce the distance between them to form a combined wing under the fixed-wing flight mode. Additionally, because of the independent control mechanisms, the rear airfoils may be deflected more downwardly to function as a trailing edge flap (FIG. 15a). This trailing edge flap as a high-lift device may be especially important when the aircraft of this invention takes off and lands like a fixed-wing aircraft with the availability of a runway.

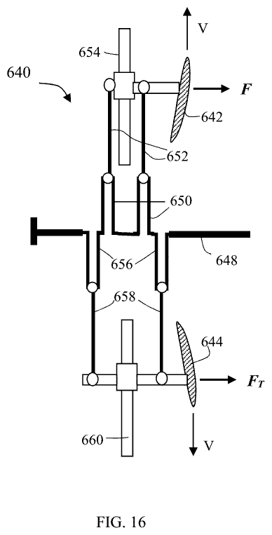

A schematic view of the thrust system 640 employing a crankshaft reciprocating driver is shown in FIG. 16. The thrust system 640 may include at least two airfoil assemblies, 642 and 644, that are configured to reciprocate in a direction generally perpendicular to the aircraft flying direction, producing a thrust F_{T} in that direction. The related members of the crankshaft driver, crankshaft 648, cranks 650 and 656, connecting rods 652 and 658, as well as the airfoil tracks 654 and 660, are also shown in the figure. Additional airfoil assemblies may be needed to more completely balance the related inertia forces and moments, and a reciprocating driver other than the crankshaft driver can also be employed for the thrust system 640 herein. It is important that the airfoils of the thrust system, such as 642 and 644 in FIG. 16, be substantially exposed to the ambient. Any supporting structures, such as 630 or 632 (such as bars, beams, or trusses) shown in FIG. 15 and FIG. 15a, are primarily for the integrity of the aircraft without significantly hindering the exposure of the airfoils to the ambient. Furthermore, the thrust system 640 may be deployed at a tail section 624 for better exposure to the ambient (not shown). The power system that is needed to drive the thrust system 640 may be a separate power system (not shown). Alternatively, the same power system, such as 612 in FIG. 15, may also be used to drive the thrust system 640.

The thrust system 640 in FIG. 15 or FIG. 15a is seen as being separated from the lift-producing airfoil assemblies 604 and being deployed between the aircraft's main body and the tail section 624. However, the thrust system 640 may be a member of the airfoil-assembly family 604 having more than one RA module, which may also produce lift. But at least one of the RA modules associated with the lift or thrust system 604 may be tilted in a more vertical position to mainly produce thrust as needed (not shown).

FIG. 17 shows schematically an embodiment of mode B when the airfoils reciprocate substantially in a horizontal direction to provide lift, while a different thrust means, such as a propeller 670, is deployed to provide thrust for the flight. In general, a thrust means, such as but not limited to, a fan, a propeller, a jet, or a jet engine, may be disposed at a suitable section of the aircraft to provide the thrust needed.

FIG. 18 illustrates schematically an embodiment of a jet engine powered aircraft according to the present invention wherein the airfoil assemblies 604a and 604b may provide needed lift during vertical takeoff and landing as well as cruise, and the jet engine 680 may provide the needed thrust during the cruise. The airfoils assemblies 604a and 604b may be powered by a separate power source, but they may also be powered by the same jet engine 680. The jet engine system 680 may include a transmission mechanism or an auxiliary turbine, 682, to extract power from the engine and drive the airfoil assemblies (or RA module) through a drive shaft 684 in conjunction with a reciprocating driver 690, such as a crankshaft driver. For the case of an auxiliary turbine, the jet engine 680 may be equipped with a gas flow control means to control the gas flow to the auxiliary turbine. During takeoff, landing, or hovering, the combustion gas after a power turbine may mostly or completely be routed to the auxiliary turbine to drive the reciprocating airfoils assemblies 604a and 604b. Once the aircraft is in the air and reaches a certain speed, the airfoils begin to function partially as fixed wings with reduced reciprocating speed and power demand. Accordingly, the percentage of the gas flow to the auxiliary turbine may be reduced, while the gas flow to the jet engine nozzle is increased for thrust. At a sufficiently high aircraft speed, the gas flow to the auxiliary turbine may be completely stopped, the airfoil assemblies would work completely as fixed wings, and the aircraft operates as a fixed-wing jet engine aircraft. If the aerodynamic interaction of the airfoils 604a and 604b under high-speed flight would affect performance, the airfoil 604b could have a substantially reduced size, just having enough mass to balance the inertia forces and moments, as shown in FIG. 18. Alternatively, the airfoil 604b could be completely removed and replaced by counterweights (not shown). Another option is to employ the reciprocating airfoils/fixed wings combination, as shown in FIG. 10a, in this jet-engine powered aircraft (not shown). Finally, the airfoils 604a and 604b may be more securely fixed to the aircraft body through fasteners when the airfoils work as fixed wings.

With respect to the embodiment of modes A-C, such as those shown in FIG. 15, FIG. 15a, FIG. 17, and FIG. 18, when the lift provided by the airfoil assemblies as the fixed wings is not enough, some or all the airfoils 604 may also reciprocate to provide additional lift. The reciprocating action, even at a substantially reduced reciprocating speed, may have the benefit of drag reduction due to a significantly decreased trailing-edge vortex level of the airfoils. Again, for all three operational modes, any suitable thrust means may be employed, not limited to the ones shown in the respective figures.

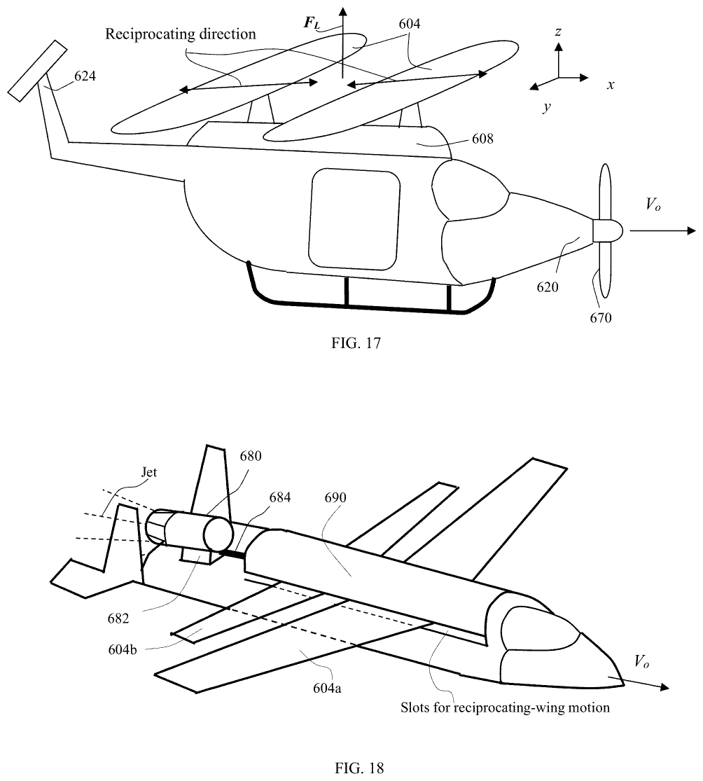

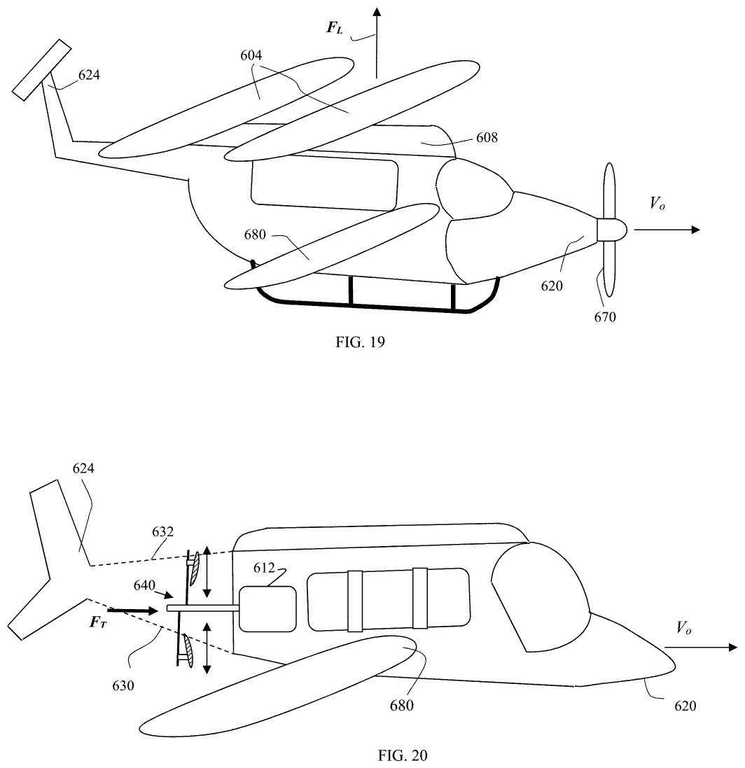

Furthermore, permanent fixed wings 680 may be added to further increase lift needed, as shown in FIG. 19 employing a propeller system for thrust. One skilled in the art may recognize that although some primary objectives of this invention are to generate lift and thrust, the reciprocating system of this invention can be employed to primarily generate thrust. In this regard, as an example, the airfoil assemblies 604 in FIG. 19, as well as the reciprocating driver system 608, may be removed. Thus, as schematically shown in FIG. 20, the fixed wings 680 would provide lift for the aircraft while the reciprocating thrust system 640 would provide thrust for the aircraft, creating a fixed-wing aircraft powered by the reciprocating thrust system of this invention. In comparison with a propeller-powered fixed-wing aircraft, the reciprocating thrust system of this invention could operate at a much higher flight speed with a significantly increased thrust-to-drag ratio. As a result, a fixed-wing aircraft equipped with the thrust system of this invention could significantly improve energy efficiency and extend the flight range.

The disclosed reciprocating lift and thrust systems according to this invention are not limited to the aircraft shown in the above embodiments; they may be employed in any aircraft within a broad category of vertical takeoff and landing (VTOL) aircraft or short takeoff and landing (STOL) aircraft, which include a variety of types of aircraft, such as fixed-wing aircraft. In addition to the aircraft for conventional transportation purposes, the reciprocating lift and thrust systems may be used for military jets, unmanned aerial vehicles (UAV) or drones, recreational aircraft, and personal vehicles. When the system of this invention works as a thrust means, it may replace the propeller or jet engine of fixed-wing aircraft and use a runway for takeoff and landing. It should be mentioned that for convenience of demonstrations, only two airfoil assemblies or one reciprocating-airfoil module are shown in the above aircraft embodiments. However, more than one airfoil module may be deployed in an aircraft.

### Flying Motor Vehicles

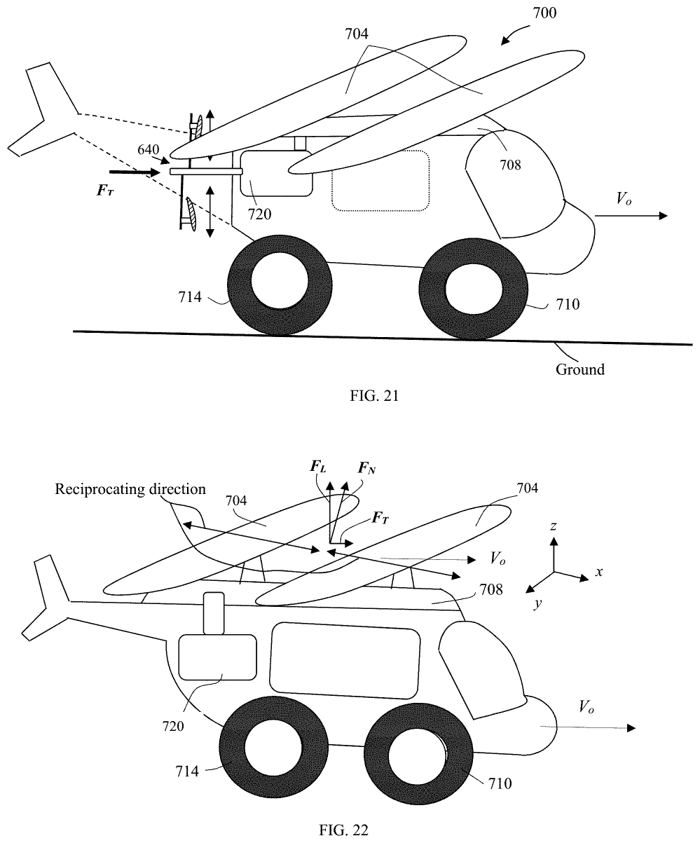

The lift or thrust system in accordance with this invention may be employed to build flying motor vehicles, such as the flying car 700, which is schematically shown in FIG. 21 when the car travels on the ground. In addition to the airfoil assemblies 704 driven by a reciprocating driver system of this invention 708 for the lift, the flying car shown in FIG. 21 may employ a reciprocating thrust system 640 of this invention to provide thrust when the car is in the air. When the car is traveling on the ground, a power system such as a combustion engine or an electric motor/battery system may be employed to drive the car (not shown). However, the reciprocating thrust system 640 may also be used to drive wheels, such as 710 or 714, on the ground (FIG. 21). A single power system, such as 720, may provide the needed power when the flying car is both in the air and on the ground. For example, when the car is on the ground, the power system 720 may disengage the reciprocating driver 708 or the thrust system 640 (if such system is deployed) and provide power for the wheels 710 or 714. However, the power system 720 may disengage the reciprocating driver 708 and provide power for the thrust system 640 to drive the wheels 710 or 714. It is also understandable that the thrust system may be powered by a separate power system (not shown) and the reciprocating thrust system 640 may be replaced by another thrust means such as a propeller.

The flying motor vehicle can share all the flying mechanisms and flying platforms of the flying vehicles illustrated in FIGS. 1-20. Once a flying car is in the air, as shown in FIG. 22, many flying modes as well as operational control mechanisms, including cyclic control and heading, may be similar to those of the embodiments related to aircraft (FIGS. 6-20), and therefore their descriptions will not be repeated herein. Furthermore, permanently fixed wings may be added to the flying car for further lift. Particularly, the fixed wings may aid in short-distance takeoff or landing, and the wings, including the reciprocating airfoils, may also be folded whenever necessary, such as the cases when the car is traveling on the ground (not shown). Although the above embodiments are related to flying cars, flying buses, flying trucks, flying motorcycles, and flying off-road vehicles can be similarly constructed using the reciprocating lift and thrust systems of this invention. Because they may use similar systems of this invention, the related illustrations are not presented herein.

### Ships, Submarine, and Boats

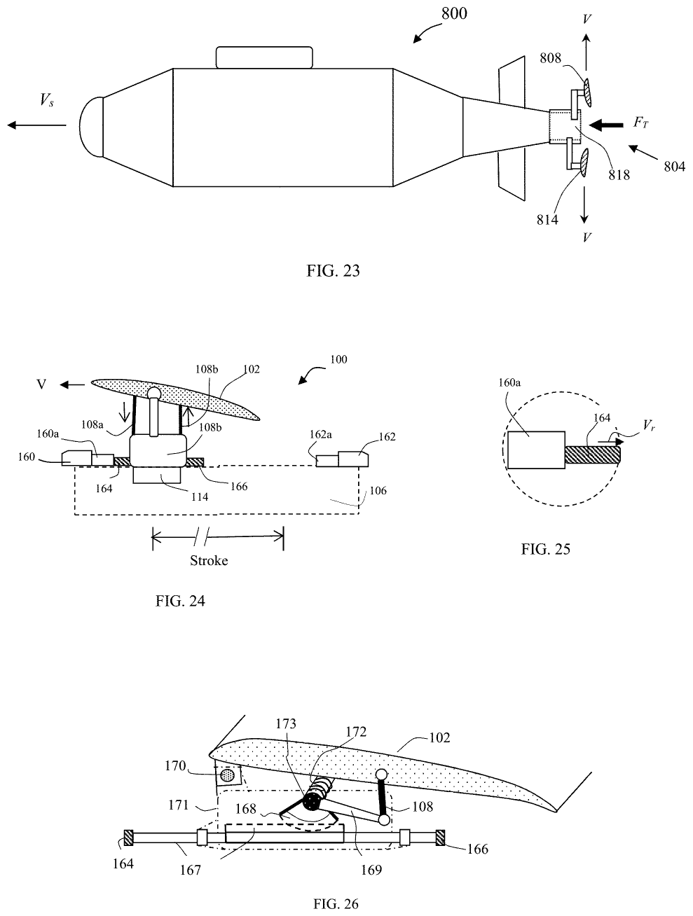

So far in this invention, a gaseous fluid such as air is involved for the operation of the airfoil assemblies of this invention. However, the thrust system of this invention can also be employed for watercraft or waterborne-vessel propulsion to generate thrust and move a ship, a submarine, or a boat across water. FIG. 23 shows schematically a submarine 800 that incorporates a reciprocating system of this invention as a thrust system 804 for the submarine propulsion. Similar to the reciprocating systems such as those shown in FIG. 7 and FIG. 16 when a mechanical driver involving a crankshaft is employed, said reciprocating thrust system includes at least two airfoil assemblies 808 and 814 submerged in the water and driven by a reciprocating driver 818. The airfoils and the reciprocating driver are so configured that a thrust F_{T} is produced by the reciprocating airfoils, which pushes the submarine forward. The reciprocating driver 818 may also be one of the other reciprocating-driver types disclosed before. Like the reciprocating system in FIG. 7, the reciprocating system in FIG. 23 may be able to substantially isolate the water surrounding the airfoils from the inside space of the submarine 800 or the reciprocating driver 818 inside of the submarine. Additionally, many embodiments of this invention related to the pitch control units, as well as the cyclic control mechanisms, may apply to this marine application. In FIG. 23, two airfoils are being seen, however additional airfoils may be employed for higher thrust and more complete balance of the inertia forces and moments. Although the illustration of the application of this invention in FIG. 23 is for a submarine, similar applications to ships or boats can be considered with the airfoil being submerged in the water. One skilled in the art may have noticed that the two airfoils, as schematically shown in FIG. 23, reciprocate vertically. However, this is for the demonstration purpose; the two airfoils may also reciprocate in other directions, such as in a horizontal direction (not shown). Because of the sufficiently high thrust-to-drag ratio of the reciprocating thrust system, the replacement of a conventional propeller for a watercraft by the system of this invention could significantly reduce the power consumption of the watercraft.

### Control Mechanisms

One of the important elements of the reciprocating lift and thrust systems disclosed is the control mechanism. Similar to a helicopter, a present vehicle capable of vertical takeoff and landing (VTOL) may also require changing the angle of attack (AoA) and cyclic control functionality through adequate control mechanisms. In general, the control mechanisms of this invention may facilitate rotating airfoils by angles, preferably near the end of a reciprocating stroke, as well as raising or lowering the airfoils. In a special case, when the rotation center of an airfoil is on an airfoil chord line but off the airfoil, the rotation of the airfoil may also have the outcome of raising or lowering the airfoil. Any control mechanism that would accommodate the needed functionality may be within the scope of this invention, which may be, but not limited to, a mechanical, electromagnetic, electrical, or hydraulic control system. Energy or action may be needed to actuate needed control activities. For example, electrical energy may be needed for triggering a control activity when an electromagnetic or electrical control unit is employed. The needed energy source may be carried with the reciprocating airfoil assembly, which, however, may increase the associated inertia force or may not be physically permissible sometimes. One of the advantages of the reciprocating system of this invention, just like many other reciprocating systems, is that the moving speed of an airfoil assembly near each dead-end of a stroke is small or nearly zero, which may provide a window of opportunity to provide mechanical action or electric power to facilitate control objectives. During the operation, the airfoil loads such as lift or thrust near the dead ends of a stroke may be nearly zero, so that the power consumption of a control mechanism could be reduced.

FIG. 24 shows schematically an airfoil assembly employing a push or pull rod (or tube) related mechanical control mechanism 108. Two stoppers, 160 and 162, are respectively disposed near the left and right dead ends of a reciprocating stroke of the airfoil assembly 102. While both stoppers do not reciprocate with the airfoil assembly, two moving contacts, 164 and 166, are part of the airfoil assembly, which may experience similar reciprocating motion but may move relative to the rest of the airfoil assembly when being actuated upon by a stopper. Referring to FIG. 24, as an example, when the stoppers are actuators, the moving contact 164 of the airfoil assembly strikes the stopper arm 160a when the airfoil is near its left dead-end of the stroke while moving from the right to the left end. An enlarged view related to this action is schematically shown in FIG. 25. The stopper 160a creates a motion of the contact 164, Vr, relative to the airfoil, from left to right, which may trigger an action of the control rod 108b to push the airfoil 102 up or an action of the rod 108a to pull the airfoil 102 down, thereby creating a counter-clockwise rotation of the airfoil 102 and generating a desired angle of attack for the next stroke from left to right. When the airfoil 102 is near the right dead end, the moving contact 166 would strike the stopper 162a, which may trigger an action of the control rod 108a to push the airfoil 102 up and an action of the rod 108b to pull the airfoil 102 down, creating a desired angle of attack for the next stroke from right to left (not shown). Springs or spring packs may be integrated with the stopper arms 160a and 162a to store or release energy during the impact engagements, respectively, with the moving contacts 164 and 166, as well as to smooth the impact and reduce noise generation.

FIG. 26 is a schematic illustration of an embodiment of the control system using a modified rack-pinion gear unit. Said unit includes a rack gear 167 with a tooth section, a contact 164 on the left and a contact 166 on the right, a pinion gear section 168 engaging the rack gear 167, and a control arm 169 that rotates with the gear section 168 and engages a push/pull rod 108. Actuated by the stoppers shown in FIG. 24, the rack gear 167 would undergo a reciprocating linear motion to actuate the reciprocating rotation of the gear section 168. This action would then, through the action of the push/pull rod 108, cause the rotation of airfoils 102 around a joint 170 clockwise or counter-clockwise to set or change the angle of attack (AoA) in reciprocating strokes. In FIG. 26, the rack-pinion gear unit is integrated with a support structure 171, such as a roller or bearing unit, which may engage the airfoil through the joint 170 and an airfoil track (not shown). For a relatively large pinion gear, the control arm 169 may be eliminated, and the gear 168 may directly engage the push/pull rod 108. To store and release energy during the reciprocating rotation of the system, a torsion spring assembly 172 may be disposed along the shaft 173 that supports the gear 168. In the embodiment shown in FIG. 26, the rotating center of the airfoil is seen near the leading edge of the airfoil 102. However, the airfoil may be rotated around any suitable center of rotation. For structural considerations, the resultant load forces of the airfoil may be near a midsection of the support structure 171.

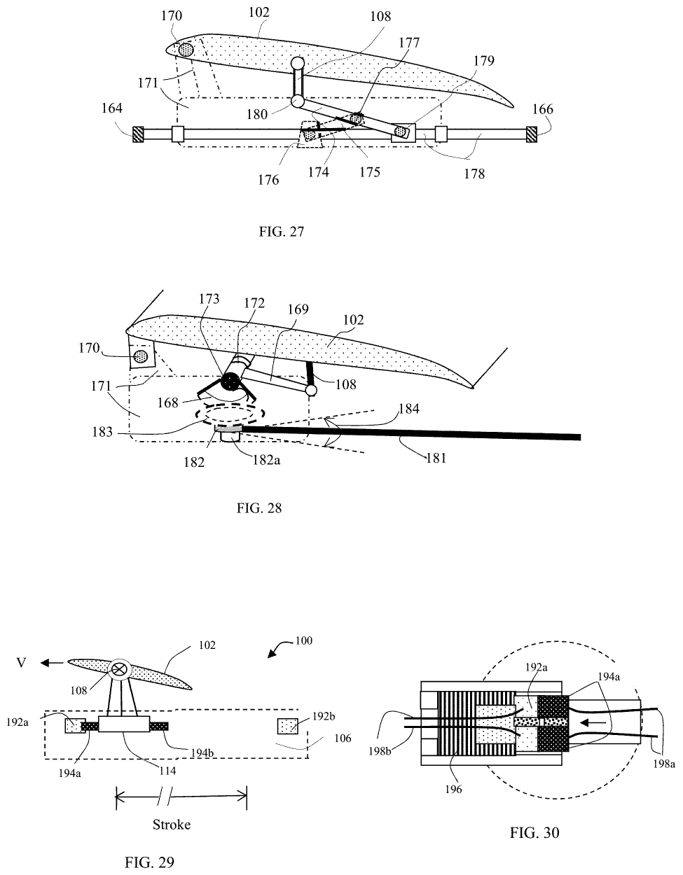

The rack-pinion gear unit in FIG. 26 may be replaced by a Scott-Russell linkage mechanism that can be used to facilitate a right-angle change of motion, as shown in FIG. 27. The linkage mechanism includes two members, 174 and 175. One end of the member 175 is hinged to the support structure 171 through a block 176 that is affixed to 171, and the other end is pinned to the member 174 at a point 177. One end of the member 174 in the figure is hinged to an actuating tube 178 at a point 179 and is driven by the actuating tube 178 to undergo a linear reciprocating motion. The other end of the member 174 engages a pull/push rod 108 through a joint 180 to create a rotation of the airfoil 102 around a rotation center 170 for changing or maintaining the angle of attack of the airfoil 102. Like the operation of the control systems in FIG. 26, the actuating tube 178 in FIG. 27 is actuated by similar stoppers (not shown).

In addition to a common need to rotate an airfoil in a stroke to set or change the angle of attack (AoA) for the following stroke, the magnitude of the effective AoA may need to be adjusted due to the change in lift demand. This may be achieved through adjusting the rotating angle of the airfoil through adjusting the position of the stopper arm or the stopper. Referring to FIG. 24, starting from a symmetric deployment of the two stopper arms, 160a and 162a, with a reference to the midsection of a stroke that may be defined based on the midsection of a roller 114 in FIG. 24, an equal amount of symmetric displacement of the two stoppers toward the midsection of the stroke could increase the rotating angle of the airfoil and subsequently its AoAs for both strokes in a reciprocating cycle. On the other hand, an equal amount of symmetric displacement of the two stoppers away from the midsection of the stroke could decrease the rotating angles of the airfoil and subsequently its AoAs for both strokes in the reciprocating cycle.

If the reciprocating motion of an airfoil is observed based on a relative coordinate system attached to the flying vehicle, a primary stroke may move in the vehicle's cruise direction and would see an airflow toward its leading edge due to the speed of the vehicle, and the AoA may be defined conventionally based on the angle between the chord line and the oncoming flow. If the same definition is applied to the reverse stroke, a negative AoA may produce lift in the reverse stroke. The reciprocating direction of an airfoil may be defined based on the average angle of attack (AoA) of the two strokes in a reciprocating cycle. A positive AoA of 25 degrees for the primary stroke and a negative AoA of 5 degrees for the reverse stroke would result in tilting the airfoil by 10 degrees relative to the flight direction. This may be interpreted as that the airfoil has tilted backward by 10 degrees. The AoA with reference to the tilted direction would be a positive 15 degree for the primary stroke. On the other hand, a positive AoA of 5 degrees for the primary stroke and a negative AoA of 25 degrees for the reverse stroke would result in tilting the airfoil by −10 degree relative to the flight direction. This may be interpreted as that the airfoil has tilted forward by a 10 degree, and the AoA with reference to the tilted direction would be positive 15 degrees for the primary stroke. The above results are based on the unweighted average AoA of the two strokes; if a weighted average on the basis of performance is used, the outcome could be changed.

A dissymmetric displacement of the two stoppers would have the effect of tilting the reciprocating direction or plane of an airfoil. As an example, starting from the symmetric deployment of both stoppers in FIG. 24, a displacement of the stopper 162a toward the midsection of the stroke with little or without the displacement of the stopper 160a would increase the angle of attack for the primary stroke of the airfoil 102 in FIG. 26 with little or no corresponding increase in the angle of attack for the reverse stroke, effectively tilting the reciprocating direction of the airfoil. During the vehicle cruise under certain conditions, the airfoil may be maintained at the desired tilting angle without change even if the airfoil is under a reciprocating motion. This may be achieved by adjusting the position of one stopper or the positions of both stoppers. Furthermore, one stopper or both stoppers may retreat away from the midsection of the stroke to a position that is out of the range of possible engagement with the corresponding moving contact such as 164 or 166 in FIG. 24 to achieve required working conditions including the deactivation of the control unit.

It should be mentioned that the angle of attack (AoA), as discussed in the above embodiments, may be an effective or average AoA in a reciprocating stroke. The actuating and changing of the angle of attack may be a dynamic process that may continue throughout the entire stroke, and the effective angle of attack may be a meaningful value that would link the effective or average lift or thrust in the stroke.

When a crankshaft mechanism is used as the reciprocating driver, the tip of the connecting rod of the crankshaft system, which may engage the support structure of the airfoil assembly and drive the airfoil, may experience reciprocating swing within a range of angle relative to the support structure. Through the use of a gear system (such as a Bevel gear system) having a functionality of transferring direction of motion, the swing motion of the connecting rod tip relative to the support structure may be used to actuate the push/pull rod to change the angle of attack of the airfoil, as shown in FIG. 28. For example, a connecting rod 181 of a crankshaft system (not shown) drives the airfoil assembly 102 through a tip 182. Said connecting rod tip is integrated with a gear (or gear section) 183 that engages the gear section 168. Because of the reciprocating rotational motion of the connecting rod tip within an angle range 184, around a hinge 182a that is an integral part of the airfoil support structure 171, the gear 183 also undergoes reciprocating rotation within the angle range, which in turn creates a reciprocating rotation of the gear section 168 to actuate the push/pull rod for the change of the angle of attack for the airfoil. Again, to store and release energy in reciprocating rotation, a torsion spring 172 may be disposed. In FIG. 28, the connecting rod 181, the gear section 183, and the gear section 168 are disposed below the shaft 173 for better illustrating the working mechanism of the system. However, they may be disposed above the shaft 173 to reduce the distance between the support structure and the airfoil (not shown).

In addition to the mechanical control units, other control units may also be used. Referring to FIG. 29, when an electromagnetic or electrical control unit is employed, the stoppers 160 and 162 in FIG. 24 may be respectively replaced by stationary contacts 192a and 192b, while the mechanical contacts 164 and 166 in FIG. 24 may be respectively replaced by moving electrical contacts 194a and 194b. In the condition shown in FIG. 29, as an example, the airfoil 102 is near the left dead-end in a stroke from right to left, and the left moving electrical contact 194a is in contact with the stationary contact 192a. An enlarged view related to this action is schematically shown in FIG. 30, wherein the moving contact 194a pushes the electrical contact of 192a to the left supported by a spring coil 196. The circuit formed by electrical wires 198a and 198b are thus closed, and electricity is supplied to the control unit 108 of the airfoil 102 to actuate the rotation of the airfoil 102 as it changes its direction and moves from the left to the right. For most figures in the embodiments of this invention, the pitch control units are shown to be push or pull rod related. However, this is for illustration purposes; other types of control units are also within the scope of this invention. For example, the control unit 108 in FIG. 29 may be in terms of a motor that rotates the airfoil 102 through a hinge to produce a positive angle of attack for the second stroke near the dead-end of the first stroke in a reciprocating cycle.

Due to the schematic nature of the drawings in the embodiments, the ratio of the stroke to the airfoil chord in the figures may not be to scale. Although a short stroke is within the scope of this invention, a longer stroke may have the benefit of reducing the reciprocating frequency requirement for a given average reciprocating speed, which in turn may be beneficial for the reduction in inertial forces and moments. A longer stroke may also have aerodynamic advantages of attaining a higher lift or thrust coefficient as well as a lift-to-drag ratio. As discussed before, the trailing-edge vortex, which may have a significant effect on the performance of a fixed-wing, may have a reduced effect on a reciprocating wing. Still, tip or trailing vortex may have certain adverse effects on a finite-span reciprocating airfoil, which may be addressed by existing techniques such as winglets, or special devices that are unique to reciprocating wings.

In some applications in which simplicity may be one of the most important factors, an airfoil may be configured to work without a pitch control unit. For example, the airfoil for this purpose may be specially designed so that in the first stroke or primary stroke with a positive angle of attack, significant lift or thrust is generated. However, in the second stroke or reverse stroke with a negative angle of attack (without the rotation near the end of the first stroke), a negative lift or thrust is produced. However, the combination of the two strokes in a cycle may still produce a meaningful lift or thrust.

As discussed before, a reciprocating lift or thrust system of this invention may be considered to work in a cycle. Accordingly, the working principle described in conjunction with FIGS. 1-4 may be regarded as working in a two-stroke cycle with substantial rectilinear motion between the two ends of a stroke. However, the airfoil may work in a cycle with more than two strokes. The airfoil may also accommodate certain non-linear motion between the two ends of a stroke for the desired lift or thrust.

The examples and embodiments described herein are for illustrative purposes only and that various modifications or changes in light thereof will be suggested to persons skilled in the art and are to be included within the spirit and purview of this application. All patents, patent applications, provisional applications, and publications referred to or cited herein are incorporated by reference in their entirety, including all figures and tables, to the extent they are not inconsistent with the explicit teachings of this specification.

### REFERENCES CITED

1. Thang010146. “Mechanism for Increasing Stroke Length 3.” YouTube video, Dec. 3, 2014. https://www.youtube.com/watch?v=ITYKygWmD9Q
2. Thang010146. “Mechanism for Increasing Stroke Length 2.” YouTube video, Dec. 3, 2014. https://www.youtube.com/watch?v=4G6mSwPguK4

What is claimed is:

1. A reciprocating lift or thrust system, comprising: at least an airfoil with a configurated angle of attack; a reciprocating driver, said driver being configured to produce a significant reciprocating linear-velocity component of said airfoil in a stroke of the reciprocating motion to generate lift or thrust; and a guiding mechanism to maintain the reciprocating motion of the airfoil.

2. The reciprocating lift or thrust system according to claim 1, further comprising at least a control unit to facilitate at least one of the following actions: rotating said airfoil by an angle, raising said airfoil, and lowering said airfoil.

3. The reciprocating lift or thrust system according to claim 2, the control unit being at least one of a mechanical control unit, an electromagnetic control unit, an electrical control unit, and a hydraulic control unit.

4. The reciprocating lift or thrust system according to claim 2, said control unit being actuated in a reciprocating stroke by an actuating means, said actuating means does not reciprocate with the airfoil and may move toward the airfoil or away from the airfoil.

5. The reciprocating lift or thrust system according to claim 1, the reciprocating driver being at least one of a mechanical driver, an electromagnetic driver, an electrical driver, and a hydraulic driver.

6. The reciprocating lift or thrust system according to claim 5, the mechanical driver being at least one of a crankshaft related slider-crank mechanism driver, a cam-follower mechanism driver, a scotch yoke mechanism driver, a swashplate mechanism driver, and a wobble (Nutator or Z-crank) driver.

7. The reciprocating lift or thrust system according to claim 5, the reciprocating driver being a hydraulic driver, said hydraulic driver including a loop of a liquid body, a larger piston in the loop driven by a reciprocating driver, and a smaller piston in the loop engaging the airfoil, thereby the stroke of the reciprocating driver being amplified to produce a longer reciprocating stroke of the airfoil.

8. The reciprocating lift or thrust system according to claim 6, said mechanical driver being a crankshaft related driver and the reciprocating stroke of the airfoil being increased without increasing the crank radius by incorporating a bar and slider mechanism; said bar driving the airfoil through a joint between the bar and said airfoil; a first, pivoted slider engaging a first section of the bar and allowing the bar to swing and slide along; and said bar being driven by a crankshaft mechanism through a second slider engaging a second section of the bar between the joint and the first section of the bar.

9. The reciprocating lift or thrust system according to claim 6, said mechanical driver being a crankshaft related driver and the reciprocating stroke of the airfoil being increased without increasing the crank radius by incorporating a bar and slider mechanism including a fixed track; said bar driving the airfoil through a first slider engaging a first section of the bar; a second, pivoted slider engaging a second section of the bar and allows the bar to swing and slide along; and said bar being driven by a crankshaft mechanism through a joint between the first and second sections of the bar, creating a reciprocating motion component of the bar at the joint along the fixed track.

10. The lift or thrust system according to claim 1, two of said reciprocating airfoils forming a reciprocating airfoil (RA) module, said two airfoils in the module being driven by the reciprocating driver and moving with almost the same velocity magnitude, but in opposite directions, to cancel out inertia forces and moments related to the acceleration or deceleration of the airfoils and their supporting structures.

11. The lift or thrust system according to claim 1, at least one reciprocating lift or thrust system being employed in a flying vehicle to provide lift or thrust for flight operations.

12. The flying vehicle according to claim 11, the airfoil in the reciprocating system tilting in a direction to provide both lift and thrust for the flying vehicle.

13. The flying vehicle according to claim 11, said reciprocating lift or thrust system producing lift for the flying vehicle while the thrust being provided by at least one of a fan, a propeller, an air jet, and a jet engine for the flying vehicle.

14. The flying vehicle according to claim 11, at least one reciprocating lift or thrust system providing thrust for the flying vehicle while the lift being provided by another reciprocating lift or thrust system for the flying vehicle.

15. The flying vehicle according to claim 11, said reciprocating lift or thrust system providing thrust for the flying vehicle while the lift being provided by fixed wings.

16. The flying vehicle according to claim 11, the reciprocating motion of said lift or thrust system being deactivated, and the airfoil of the reciprocating lift or thrust system functions as a fixed wing to utilize the vehicle's speed to generate lift under sufficiently high speed of the vehicle.

17. The flying vehicle according to claim 11, the reciprocating driver in the reciprocating lift or thrust system being a crankshaft related driver, the crankshaft of said system being disposed in a generally perpendicular direction to the flying vehicle's top or bottom surface of the main body.

18. The flying vehicle according to claim 11, the airfoil in said reciprocating lift or thrust system being shaped like a wing of a fixed-wing airplane and being disposed with its span generally perpendicular to a front-back direction of the flying vehicle; said airfoil working in at least one of the following operational modes: reciprocating in the front-back direction to generate lift during flying vehicle's takeoff, landing, or hovering utilizing the flying vehicle's flight speed to generate lift while working under reduced reciprocating speed; and utilizing the flying vehicle's flight speed to generate lift under the non-reciprocating condition.

19. The flying vehicle according to claim 11, at least two airfoils in said reciprocating lift or thrust system being disposed with their spans generally parallel to a front-back direction of the vehicle; said airfoils reciprocating in a lateral direction generally perpendicular to the front-back direction and being guided and supported, respectively, by at least one of the following two kinds of structures: laterally disposed track structures and two fixed wings, said fixed wings generating additional lift for the flying vehicle.

20. The flying vehicle according to claim 11, said flying vehicle being at least one of a vertical takeoff and landing (VTOL) aircraft, a short takeoff and landing (STOL) aircraft, an unmanned aerial vehicle (UAV), a recreational aircraft, a personal aircraft, and a fixed-wing aircraft.

21. The flying vehicle according to claim 11, said flying vehicle being at least one of a flying car, a flying bus, a flying truck, a flying motorcycle, and a flying off-road vehicle.

22. The thrust system according to claim 10, said reciprocating thrust system being employed in at least one of a submarine, a ship, and a boat, to provide thrust for watercraft propulsion, while said airfoils of the system being submerged in the water and the water being substantially separated from the inside space of the watercraft by a partition structure.

23. The control unit according to claim 2, said control unit being at least one of a rack-pinion gear-related unit, a Scott-Russell linkage mechanism related unit, and a control unit that facilitates said actions by utilizing the reciprocating rotational motion of the connecting rod of a crankshaft driver relative to a hinge of an airfoil's supporting structure.
